(19) United States
(12) Patent Application Publication
(10) Pub. No.: US 2016/0134317 A1
(43) Pub. Date: May 12, 2016

(54) SYSTEM AND METHODS FOR DYNAMICALLY MANAGING RECEIVE MODES TO IMPROVE PERFORMANCE ON A MULTI-SUBSCRIBER IDENTITY (SIM) WIRELESS COMMUNICATION DEVICE

(71) Applicant: QUALCOMM Incorporated, San Diego, CA (US)

(72) Inventors: An-swol Clement HU, Belmont, CA (US); Reza Shahidi, San Diego, CA (US); Chintan Shirish Shah, San Diego, CA (US); Jun Hu, San Diego, CA (US); Stanley Suyi Tsai, Frederick, CO (US); Parth AshwinKumar Pandya, Boulder, CO (US); Shanshan Wang, San Diego, CA (US); Qingxin Chen, Del Mar, CA (US); Hari Sankar, San Diego, CA (US); Qiang Shen, San Diego, CA (US); Thawatt Gopal, San Diego, CA (US); Divaydeep Sikri, Woking (GB)

(21) Appl. No.: 14/673,851

(22) Filed: Mar. 30, 2015

Related U.S. Application Data
(60) Provisional application No. 62/078,163, filed on Nov. 11, 2014.

(51) Int. Cl. H04B 1/3816; H04W 68/02

(52) U.S. Cl. CPC H04B 1/3816; H04W 68/02

(57) ABSTRACT

Methods and devices for implementing dynamic receive mode management to improve data throughput and paging performance on a multi-subscriber identification module (SIM) wireless communication device may include detecting, on a protocol stack associated with a first SIM, an active communication in a first network, detecting, on a protocol stack associated with a second SIM, an idle mode paging cycle in a second network, prompting entry into a selected dual receive mode on the shared RF resource, and monitoring at least one performance metric for the idle mode paging cycle associated with the second SIM while in the dual receive mode. Based on the monitored performance metric while in the dual receive mode, the wireless communication device may determine whether paging performance is degraded for the second SIM, and if so, trigger entry into a fallback mode on the shared RF resource.

### RELATED APPLICATIONS

This application claims the benefit of priority to U.S. Provisional Patent Application No. 62/078,163, entitled “System and Methods for Dynamically Managing Receive Modes to Enhance Performance on a DSDS Wireless Communication Device” filed Nov. 11, 2014, the entire contents of which are hereby incorporated herein by reference.

### BACKGROUND

Multi-subscriber identity module (SIM) wireless communication devices have become increasing popular because of the versatility that they provide, particularly in countries where there are many service providers. For example, dual-SIM wireless communication devices may allow a user to implement two different plans or service providers, with separate numbers and bills, on the same device (e.g., business account and personal account). Also, during travel, users can obtain local SIM cards and pay local call rates in the destination country. By using multiple SIMs, a user may take advantage of different pricing plans and save on mobile data usage.

In various types of multi-SIM wireless communication devices, each protocol stack associated with a subscription may store information provisioned by its respective network operator in a SIM, which may allow the SIM to support use of various different communication services. For example, various wireless networks may be configured to handle different types of data, use different communication modes, implement different radio access technologies, etc.

One type of multi-SIM wireless communication device, referred to as a multi-SIM multi-standby (MSMS) device, enables at least two SIMs to be in idle mode waiting to begin communications, and but only allows one SIM at a time to participate in an active communication due to sharing of a single radio frequency (RF) resource (e.g., transceiver). Some MSMS wireless devices may be configured with two SIMs, enabling multi-standby on both SIMs (i.e., dual-SIM dual-standby (DSDS) devices). Other MSMS wireless devices may extend this capability to more than two SIMs, and may be configured with any number of SIMs greater than two.

Multi-SIM wireless devices can have multiple subscriptions to one or more wireless networks. Since a MSMS wireless device typically time-shares use of a single RF resource to communicate over the multiple SIMs and/or networks, the wireless device can only actively communicate using a single SIM and/or network at a given time. As such, using an active communication using one SIM (e.g., the first SIM), the wireless device may periodically tune away to a network associated with another SIM in idle mode (e.g., the second SIM) to monitor signals (e.g., pages) or acquire a connection. In some MSMS devices, the RF resource is configured with multiple receive chains to allow receive diversity (e.g., multiple antennas and/or other front end RF components that receive copies of the same signal). Therefore, tune-aways to the network associated with the second SIM may involve tuning away with one or multiple receive chains associated with the RF resource.

During such tune-aways, the wireless device may lose the downlink information on the active communication, thereby reducing throughput on the active communication. To mitigate such effects, some MSMS device are configured with capabilities to enter one or more dual receive mode in which one or more receive chain associated with the RF resource can be used to simultaneously receive signals on the network associated with the idle mode SIM. However, while generally beneficial, simultaneously receiving signals from different networks can introduce RF coexistence problems that can degrade performance, particularly for decoding the paging channel. As such, reverting to the conventional time sharing of the RF resource (i.e., tuning away to the second network) may have a better overall result in certain scenarios.

### SUMMARY

Systems, methods, and devices of various embodiments may enable a wireless communication device configured to use at least a first subscriber identity module (SIM) and a second SIM associated with a shared radio frequency (RF) resource to implement dynamic receive mode management for improving data throughput and page performance by detecting when a communication of the first SIM will occur at the same time as an idle mode paging cycle in a second network associated with the second SIM, prompting entry into a dual receive mode on the shared RF resource, determining whether paging performance is degraded on a protocol stack associated with the second SIM based on the at least one performance metric monitored while in the dual receive mode, and triggering entry into a fallback mode on the shared RF resource in response to determining that paging performance is degraded on the protocol stack associated with the second SIM. In some embodiments, in the dual receive mode the shared RF resource may be tuned to a first network and at least one receive chain associated with the shared RF resource may be used for each of receiving signals from the first network and monitoring a paging channel in the second network. In some embodiments, the RF resource may tune away from the first network and tune to the second network during paging periods associated with the second SIM while in the fallback mode.

Various embodiments may include monitoring at least one performance metric for the idle mode paging cycle associated with the second SIM while in the fallback mode, determining whether the paging performance on the protocol stack associated with the second SIM has improved based on the at least one performance metric monitored while in the fallback mode, and prompting the shared RF resource to exit the fallback mode and re-enter the dual receive mode in response to determining that the paging performance on the protocol stack associated with the second SIM has improved. Various embodiments may include prompting the shared RF resource to exit the fallback mode and re-enter the dual receive mode following expiration of a preset timer in response to determining that the paging performance on the protocol stack associated with the second SIM has not improved in the fallback mode.

Various embodiments may include determining whether the degraded paging performance is likely a result of factors other than the dual receive mode in response to determining that the paging performance on the protocol stack associated with the second SIM has not improved in the fallback mode, and prompting the shared RF resource to exit the fallback mode and re-enter the dual receive mode in response to determining that the degraded paging performance is likely a result of factors other than the dual receive mode. In some embodiments, detecting when a communication of the first SIM will occur at the same time as an idle mode paging cycle in a second network associated with the second SIM may include detecting an active communication in the first network on a protocol stack associated with the first SIM, and detecting an idle mode paging cycle in the second network on the protocol stack associated with the second SIM.

In some embodiments, determining whether the paging performance is degraded on the protocol stack associated with the second SIM may include comparing a current value of the at least one performance metric to at least one corresponding entrance threshold. In some embodiments, determining whether the paging performance on the protocol stack associated with the second SIM has improved may include comparing a current value of the at least one performance metric to at least one corresponding exit threshold. In some embodiments, the corresponding exit threshold may be a value equal to the corresponding entrance threshold. In some embodiments, the corresponding exit threshold may be a value different from the corresponding entrance threshold.

In some embodiments, monitoring at least one performance metric for the idle mode paging cycle associated with the second SIM while in the dual receive mode may include monitoring at least one of a pilot channel quality measurement, a paging indicator (PI) bit value, a demodulation failure rate, a received signal strength, an idle mode cyclic redundancy check (CRC) failure rate, a current downlink signal failure counter (DSC) value, a glitch percentage, a desense percentage, a receive automatic gain control (AGC) value, and a quick paging channel (QPCH) channel estimate.

In some embodiments, monitoring at least one performance metric for the idle mode paging cycle associated with the second SIM while in the fallback mode may include monitoring at least one of a pilot channel quality measurement, a paging indicator (PI) bit value, a demodulation failure rate, a received signal strength, an idle mode cyclic redundancy check (CRC) failure rate, a current downlink signal failure counter (DSC) value, an average paging channel (PCH) burst signal-to-noise ratio (SNR), a receive automatic gain control (AGC) value, and a quick paging channel (QPCH) channel estimate.

Various embodiments include a wireless communication device including a wireless communication device configured to use at least a first SIM and a second SIM associated with a shared radio frequency (RF) resource, respectively, and a processor configured with processor-executable instructions to perform operations of the methods described above. Various embodiments also include a non-transitory processor-readable medium on which are stored processor-executable instructions configured to cause a processor of a wireless communication device to perform operations of the methods described above. Various embodiments also include a wireless communication device having means for performing functions of the methods described above.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a communication system block diagram of a network suitable for use with various embodiments.

FIG. 2 is a block diagram illustrating a wireless communication device according to various embodiments.

FIG. 3 is a block diagram illustrating an example configuration of elements that are associated with switching between receive modes on a multi-SIM wireless communication device according to various embodiments.

FIGS. 4A and 4B are process flow diagrams illustrating a general method for implementing dynamic receive mode management in an example multi-SIM wireless communication device according to various embodiments.

FIGS. 5A-5C are process flow diagrams illustrating another example method for implementing dynamic receive mode management in an example multi-SIM wireless communication device according to various embodiments.

FIGS. 6A and 6B are process flow diagrams illustrating another example method for implementing dynamic receive mode management in an example multi-SIM wireless communication device according to various embodiments.

FIG. 7 is a process flow diagram illustrating another example method for implementing dynamic receive mode management in an example multi-SIM wireless communication device according to various embodiments.

FIG. 8 is a process flow diagram illustrating another example method for implementing dynamic receive mode management in an example multi-SIM wireless communication device according to various embodiments.

FIG. 9 is a component diagram of an example wireless communication device suitable for use with various embodiments.

FIG. 10 is a component diagram of another example wireless communication device suitable for use with various embodiments.

### DETAILED DESCRIPTION

Various embodiments will be described in detail with reference to the accompanying drawings. Wherever possible the same reference numbers will be used throughout the drawings to refer to the same or like parts. References made to particular examples and implementations are for illustrative purposes, and are not intended to limit the scope of the claims.

The various embodiments provide methods and apparatuses for improving performance of communications associated with different SIMs in a wireless device configured with a shared RF resource. In particular, the various embodiments may enhance device performance and minimize any potential harmful interaction between radio access technologies by dynamically switching between receive modes when communications of a first SIM using diversity mode collides with communications of a second SIM that is in an idle mode. This may occur when idle mode communications (e.g., an idle mode paging cycle) of the first SIM collide with idle mode communications of the second SIM, and when the first SIM is in an active communication and the second SIM is in an idle mode. In various embodiments, a receive mode manager on the wireless device may be configured to implement a dual receive mode by default, thereby enhancing throughput on an active communication compared to tuning away to the paging channel for the second SIM. If a threshold level of performance drop occurs on the second SIM, such as in decoding the paging channel, the wireless device may switch to a “legacy” (i.e., fallback) mode in which the RF resource is time-shared between the subscriptions supported by the two or more SIMs. Since the receive activity is restricted to one radio access technology at a time in the fallback mode, the RF resource may be tuned away from the first network for performing idle mode activity associated with the second SIM (e.g., receiving the paging channel for the second SIM), ensuring full performance. Once the performance improves, and/or if use of the fallback mode is not causing improvement in performance after a period of time, the wireless device may transition back to using the dual receive mode in the active communication for the first SIM and to monitor the paging channel for the second SIM.

The terms “wireless device,” “mobile device,” and “wireless communications device” are used interchangeably herein to refer to any one or all of cellular telephones, smart phones, personal or mobile multi-media players, personal data assistants (PDAs), laptop computers, tablet computers, smart books, palm-top computers, wireless electronic mail receivers, multimedia Internet enabled cellular telephones, wireless gaming controllers, and similar personal electronic devices that include a programmable processor and memory and circuitry for establishing wireless communication pathways and transmitting/receiving data via wireless communication pathways enabled by two or more SIMs.

As used herein, the terms “SIM,” “SIM card,” and “subscriber identification module” are used interchangeably to refer to a memory that may be an integrated circuit or embedded into a removable card, and that stores an International Mobile Subscriber Identity (IMSI), related key, and/or other information used to identify and/or authenticate a wireless device on a network and enable a communication service with the network. Because the information stored in a SIM enables the wireless device to establish a communication link for a particular communication service or services with a particular network, the term “SIM” is also be used herein as a shorthand reference to the communication service associated with and enabled by the information stored in a particular SIM as the SIM and the communication network, as well as the services and subscriptions supported by that network, correlate to one another. Similarly, the term SIM may also be used as a shorthand reference to the protocol stack and/or protocol stack and communication processes used in establishing and conducting communication services with subscriptions and networks enabled by the information stored in a particular SIM. For example, references to assigning an RF resource to a SIM (or granting a SIM radio access) means that the RF resource has been allocated to establishing or using a communication service with a particular network that is enabled by the information stored in that SIM.

As used herein, the terms “wireless network,” “cellular network,” and “cellular wireless communication network” are used interchangeably to refer to a portion or all of a wireless network of a carrier associated with a wireless device and/or subscription on a wireless device.

As used herein, the terms “diversity,” “receive diversity,” “diversity reception,” and “receiver diversity” are used interchangeably to refer to processing a downlink/forward link signal by input to multiple receive chains in a wireless communications device. For example, at least two antennas provide at least two different inputs signals to a receiver, each of which has a different multi-path.

As used herein, the terms “power-saving cycle,” “power-saving mode,” “discontinuous reception,” and “DRX cycle” are used interchangeably to refer to an idle mode process that involves alternating sleep periods (during which power consumption is minimized) and awake (or “wake-up”) periods in which normal power consumption and reception are returned, and the wireless device monitors a channel by normal reception. The length of a power-saving cycle or DRX cycle, measured as the interval between the start of an awake period and the start of the next awake period, is typically signaled by the network.

As used herein, the terms “subscription,” “SIM,” “SIM card,” and “subscriber identification module” are used interchangeably to mean a memory that may be an integrated circuit or embedded into a removable card, which stores an International Mobile Subscriber Identity (IMSI), related key, and/or other information used to identify and/or authenticate a wireless device on a network. Examples of SIMs include the Universal Subscriber Identity Module (USIM) provided for in the LTE 3GPP standard, and the Removable User Identity Module (R-UIM) provided for in the 3GPP2 standard. Universal Integrated Circuit Card (UICC) is another term for SIM.

The terms subscription and SIM may also be used as shorthand reference to a communication network associated with a particular SIM, since the information stored in a SIM enables the wireless device to establish a communication link with a particular network, thus the SIM and the communication network, as well as the services and subscriptions supported by that network, correlate to one another.

As used herein, the terms “multi-SIM multi-standby communication device” and “MSMS communication device” are used interchangeably to describe a wireless communication device that is configured with more than one SIM and allows idle-mode operations to be performed on two networks simultaneously, as well as selective communication on one network while performing idle-mode operations on at least one other network.

As used herein, the term “RF resource” refers to the components in a wireless communication device that send, receive, and decode radio frequency signals. An RF resource typically includes a number of components coupled together that transmit RF signals that are referred to as a “transmit chain,” and a number of components coupled together that receive and process RF signals that are referred to herein as a “receive chain” or “RF receive chain.”

Modern mobile communication devices (e.g., smartphones) may now include a plurality of SIM cards that enable a user to connect to different mobile networks while using the same mobile communication device. Each SIM card serves to identify and authenticate a subscriber using a particular mobile communication device, and each SIM card is associated with only one subscription. For example, a SIM card may be associated with a subscription to one of a GSM, TD-SCDMA, CDMA2000, and/or WCDMA system. Further, controlling receive diversity may be applicable to any of a number of wireless communication system, using various multiple access schemes, such as, but not limited to, Code Division-Multiple Access (CDMA), Frequency Division-Multiple Access (FDMA), Orthogonal Frequency Division Multiple Access (OFDMA), or Time Division-Multiple Access (TDMA). Examples of CDMA multiple access schemes include but are not limited to TIA/EIA/IS-95, TIA/EIA/IS-2000 or CDMA2000, 1xEV-DO, 1xEV-DV, 802.11a, 802.11b, 802.11g, 802.11n, 802.11ac, WIMAX, and WCDMA. Embodiments described herein may also extend to Long Term Evolution (LTE) wireless communication systems, thereby extending receive mode control operations to opportunistic multiple-input multiple-output (MIMO). The embodiments described herein may be used in any wireless system having two or more antennas and/or RF receive chain components that are part of or coupled to a shared RF resource.

While specific embodiments may be described herein with reference to a degree of multi-access/multi-standby of two (i.e., two SIMs and protocol stacks) and a degree of diversity of two for a particular SIM (i.e., two antennas, two RF receive chains, etc.), such references are used as example and are not meant to preclude embodiments using three or more RF receive chains to provide receive diversity. The terms “receive chain” and “RF receive chain” are used interchangeably herein, and may include various physical and/or logical components of the RF resource for use in receive operations, whether or not receive diversity is used at the time. Such portions of the RF resource may include, without limitation, an RF front end, and components of the RF front end (including a receiver unit). In the various embodiments, an RF receive chain may also include at least one antenna. Portions of an RF receive chain may be integrated into a single chip, or distributed over multiple chips. Also, the RF receiver chain, or portions of the receiver chain may be integrated into a chip along with other functions of the wireless device. The embodiments described herein may be used in wireless systems having two or more antennas coupled to at least one receive component.

Wireless communication networks are widely deployed to provide various communication services such as telephony, video, data, messaging, broadcasts, and so on. Such networks, which are usually multiple access networks, support communications for multiple users by sharing the available network resources. One example of such a network is the UMTS Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). The UMTS also supports enhanced 3G data communications protocols, such as High Speed Packet Access (HSPA), which provides higher data transfer speeds and capacity to associated UMTS networks.

In some wireless networks, a wireless communication device may have multiple subscriptions to one or more networks (e.g., by employing multiple subscriber identity module (SIM) cards or otherwise). Such a wireless communication device may include, but is not limited to, a multi-SIM multi-standby (MSMS) communication device (e.g., a dual-SIM dual-standby (DSDS) communication device). For example, a first subscription may be a first technology standard, such as Wideband Code Division Multiple Access (WCDMA), while a second subscription may support the same technology standard or a second technology standard, such as Global System for Mobile Communications (GSM) Enhanced Data rates for GSM Evolution (EDGE) (also referred to as GERAN).

A multi-SIM wireless device that supports two or more SIMs may have a number of capabilities that provide convenience to a user, such as allowing different wireless carriers, plans, telephone numbers, billing accounts, etc. on one device. Developments in multi-SIM wireless communication device technology have led to a variety of different options for such devices. For example, an “active multi-SIM” wireless communication device allows at least two SIMs to remain active and accessible to the device. In particular, a type of active multi-SIM wireless communication device may be a MSMS wireless communication device in which at least two SIMs are configured to share a single transceiver (i.e., RF resource).

In various embodiments, the RF resources of a MSMS device may be configured to be shared between a plurality of SIMs, but may be employed by default to perform communications on a network enabled by a first SIM, such as a network capable of high-speed data communications (e.g., WCDMA, HSDPA, LTE, etc.). As such, a protocol stack associated with a second SIM of the device may often be in idle mode with respect to a second network. Depending on the radio access technology of the second network, such idle mode states may involve implementing a power saving mode that includes a cycle of sleep and awake states. For example, if the second network is a GSM network, during idle mode the protocol stack associated with the second SIM may implement discontinuous reception (DRX).

During a wake-up period (i.e., awake state), the timing of which may be set by the second network for a paging group to which the second SIM belongs. The protocol stack associated with the second SIM may attempt to use the shared RF resource to monitor a paging channel of the second network for paging requests. During the sleep state, the protocol stack may power off most processes and components, including the associated RF resource. In some networks, such as GSM networks, the duration of time in the wake-up period that may be used to monitor/decode messages on the paging channel may be around 6 ms. The duration of a complete power-saving mode cycle (e.g., DRX cycle), measured as the interval between the start of consecutive wake-up periods, may typically be 470 ms. Similarly, the paging cycle in such embodiments (e.g., the interval between the start of consecutive scheduled page decode/monitoring times) may typically also be 470 ms.

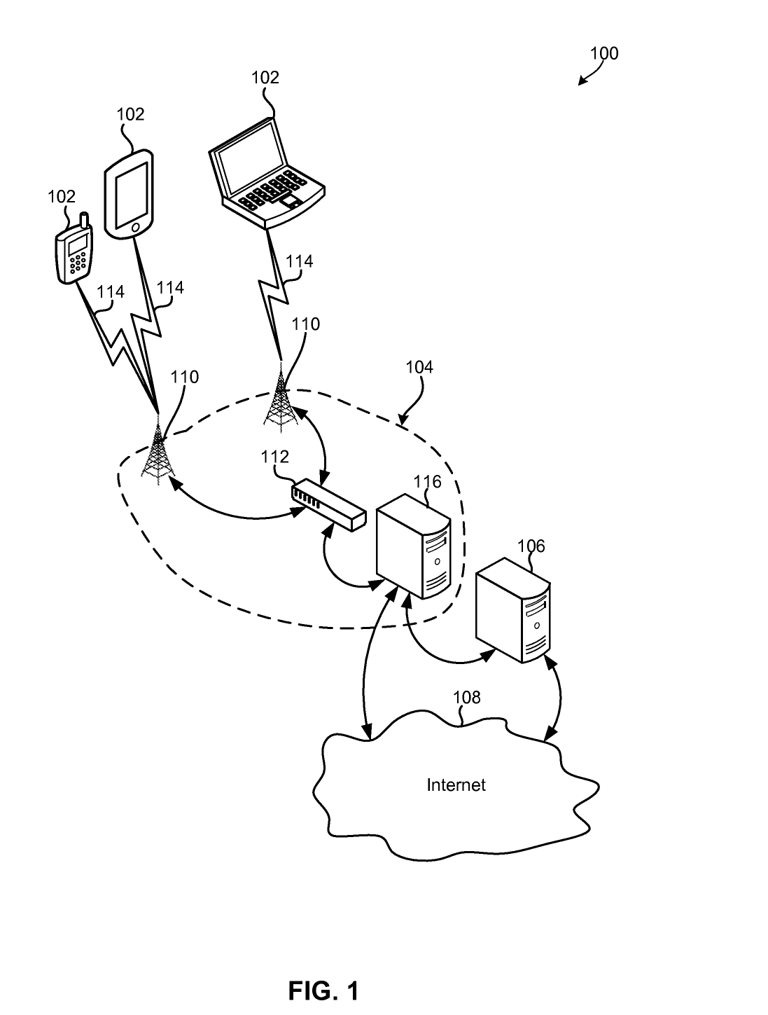

Various embodiments may be implemented within a variety of communication systems, such as the example communication system 100 illustrated in FIG. 1. The communication system 100 may include one or more wireless devices 102, a telephone network 104, and network servers 106 coupled to the telephone network 104 and to the Internet 108. In some embodiments, the network server 106 may be implemented as a server within the network infrastructure of the telephone network 104.

A typical telephone network 104 includes a plurality of cell base stations 110 coupled to a network operations center 112, which operates to connect voice and data calls between wireless devices 102 (e.g., tablets, laptops, cellular phones, etc.) and other network destinations, such as via telephone land lines (e.g., a POTS network, not shown) and the Internet 108. The telephone network 104 may also include one or more servers 116 coupled to or within the network operations center 112 that provide a connection to the Internet 108 and/or to the network servers 106. Communications between the wireless devices 102 and the telephone network 104 may be accomplished via two-way wireless communication links 114, such as GSM, UMTS, EDGE, 4G, 3G, CDMA, TDMA, LTE, and/or other communication technologies.

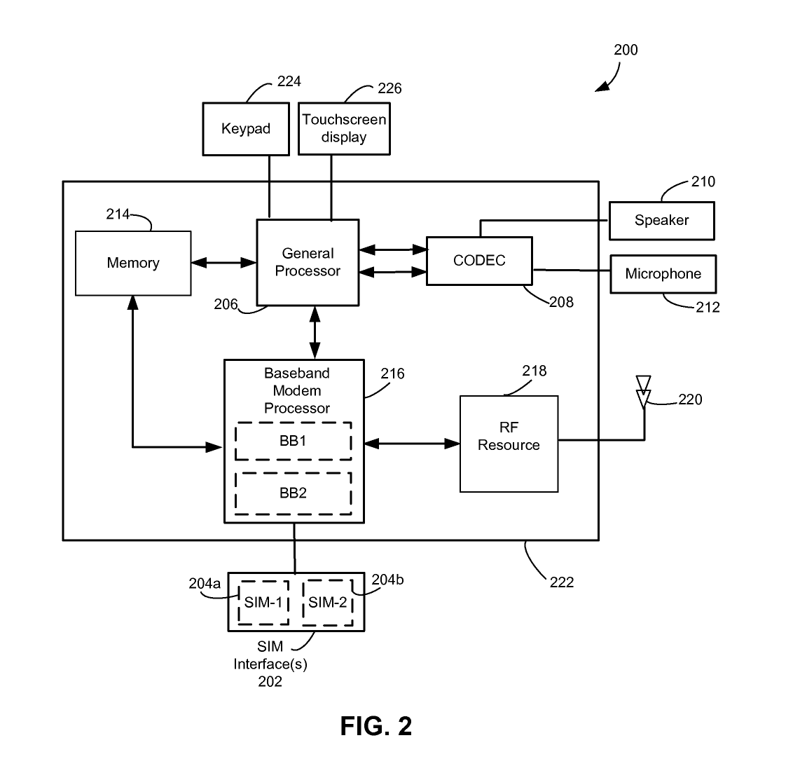

FIG. 2 is a functional block diagram of an example wireless communication device 200 that is suitable for implementing various embodiments. According to various embodiments, the wireless device 200 may be similar to one or more of the wireless devices 102 described with reference to FIG. 1. With reference to FIGS. 1-2, the wireless device 200 may be a single-SIM wireless communication device, or a multi-SIM wireless communication device. The wireless device 200 may include at least one SIM interface 202, which may receive a first SIM (“SIM-1”) 204a that is associated with a first subscription. In some embodiments, the at least one SIM interface 202 may be implemented as multiple SIM interfaces 202, which may receive at least a second SIM (“SIM-2”) 204b that is associated with at least a second subscription.

A SIM in various embodiments may be a Universal Integrated Circuit Card (UICC) that is configured with SIM and/or USIM applications, enabling access to GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card.

Each SIM 204a, 204b may have a CPU, ROM, RAM, EEPROM and I/O circuits. One or more of the first SIM 204a and second SIM 204b used in various embodiments may contain user account information, an IMSI a set of SIM application toolkit (SAT) commands and storage space for phone book contacts. One or more of the first SIM 204a and second SIM 204b may further store home identifiers (e.g., a System Identification Number (SID)/Network Identification Number (NID) pair, a Home PLMN (HPLMN) code, etc.) to indicate the SIM network operator provider. An Integrated Circuit Card Identity (ICCID) SIM serial number may be printed on one or more SIM 204 for identification.

The wireless device 200 may include at least one controller, such as a general-purpose processor 206, which may be coupled to a coder/decoder (CODEC) 208. The CODEC 208 may in turn be coupled to a speaker 210 and a microphone 212. The general purpose processor 206 may also be coupled to at least one memory 214. The memory 214 may be a non-transitory tangible computer readable storage medium that stores processor-executable instructions. For example, the instructions may include routing communication data relating to a subscription though the transmit chain and receive chain of a corresponding baseband-RF resource chain. The memory 214 may store operating system (OS), as well as user application software and executable instructions. The general purpose processor 206 and memory 214 may each be coupled to at least one baseband-modem processor 216. Each SIM 204a, 204b in the wireless device 200 may be associated with a baseband-RF resource chain that includes at least one baseband-modem processor 216 and at least one RF resource 218.

In some embodiments, the wireless device 200 may be an MSMS device, such as a DSDS device, with both SIMs 204a, 204b sharing a single baseband-RF resource chain that includes the baseband-modem processor 216—which may perform baseband/modem functions for communicating with/controlling a radio access technology—and an RF resource 218. In some embodiments, the shared baseband-RF resource chain may include, for each of the first SIM 204a and the second SIM 204b, separate baseband-modem processor 216 functionality (e.g., BB1 and BB2). The RF resource 218 may be coupled to at least one antenna 220, and may perform transmit/receive functions for the wireless services associated with each SIM 204a, 204b of the wireless device 200. The RF resource 218 may implement separate transmit and receive functionalities, or may include a transceiver that combines transmitter and receiver functions.

In some embodiments, the general purpose processor 206, memory 214, baseband-modem processor 216, and RF resource 218 may be included in a system-on-chip device 222. The first and second SIMs 204a, 204b and their corresponding interface(s) 202 may be external to the system-on-chip device 222. Further, various input and output devices may be coupled to components of the system-on-chip device 222, such as interfaces or controllers. Example user input components suitable for use in the wireless device 200 may include, but are not limited to, a keypad 224 and a touchscreen display 226.

In some embodiments, the keypad 224, touchscreen display 226, microphone 212, or a combination thereof, may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive selection of a contact from a contact list or to receive a telephone number. As another example, the request to initiate the outgoing call may be in the form of a voice command received via the microphone 212. Interfaces may be provided between the various software modules and functions in the wireless device 200 to enable communication between them, as is known in the art.

In this manner, in a DSDS wireless device, such as the wireless device 200, the RF resource 218 may be associated with multiple SIMs (e.g., 204a, 204b) and their corresponding protocol stacks, which may maintain some independent functionality when the wireless device is configured with multiple antennas and/or other RF receive chain components. In particular, certain DSDS device configurations may provide receive diversity on at least one SIM through appropriate network support, as well as baseband-modem processor and RF capabilities configured on the device. For example, the RF resource 218 may be configured with multiple RF front end components (e.g., antennas) that form simultaneous receive chains associated with at least one SIM. When the device is performing idle mode communications or participating in an active communication on a SIM (e.g., an ongoing data session or voice call), multiple RF receive chains may be used by the RF resource to support that communication, thereby implementing receive diversity. Such receive diversity may provide dramatic improvement in data throughput, and may prevent dropped calls in weak coverage areas.

If supported by the baseband-modem processor and radio access technologies associated with the serving networks of the first and second SIMs, a MSMS device in the various embodiments may avoid tuning away from the active communication by implementing a dual receive mode. Specifically, in a dual receive mode, the MSMS device may simultaneously participate in the active communication on the first SIM and receive the paging channel for the second SIM. Example dual receive modes that may be implemented include a diversity sharing mode and a full concurrency mode. In the diversity sharing mode, receive diversity may be enabled for the active communication on the first SIM through two associated RF receive chains. While the second SIM is in the idle mode sleep state, the second SIM is inactive on all associated RF receive chains. Once the second SIM enters a wake-up period to monitor its paging channel, receive diversity may be disabled on the first SIM and one of the RF receive chains associated with the first SIM may be re-purposed to tune to the network for receiving pages on the second SIM. That is, during the wake-up period, each SIM utilizes one of the RF receive chains that are typically both used for communications on the first SIM. Also, when the first SIM is in an idle mode and its idle mode communications collide with idle mode communications of the second SIM, similar operations may be performed to support both sets of idle mode communications.

In the full concurrency mode, receive diversity is also enabled for the active communication on the first SIM while the second SIM in the idle mode sleep state is inactive on its associated RF receive chain(s). When the second SIM enters the wake-up period, the RF resource is simultaneously used to receive the paging channel in the network associated with the second SIM. That is, in full concurrency mode, the MSMS device maintains receive diversity on the active communication for the first SIM while using at least one other RF receive chain (i.e., those associated with the second SIM) to receive the paging channel.

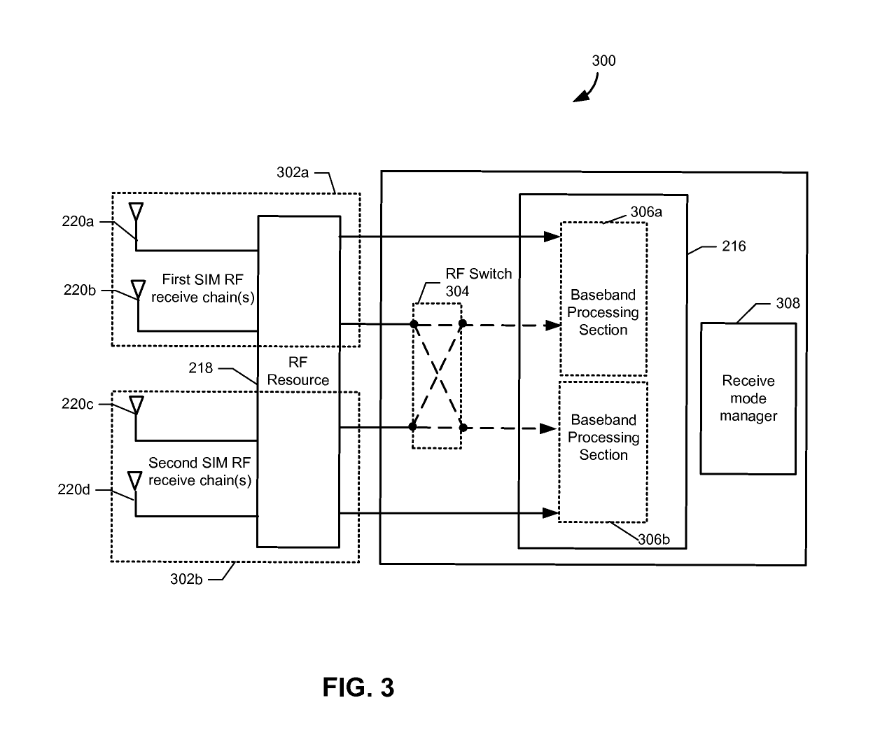

FIG. 3 illustrates a configuration 300 of receive elements that may interact in a wireless device to provide one or both of the dual receive modes according to various embodiments. Referring to FIGS. 1 and 2, such receive elements may be functions and/or components of the wireless device 200. With reference to FIGS. 1-3, in the configuration 300, one or more RF receive chains may typically be associated with receive functions on the first SIM (i.e., “SIM-1 RF receive chain(s)” 302a), while one or more RF receive chains may typically be associated with receive functions on the second SIM (i.e., “SIM-2 RF receive chain(s)” 302b). In various embodiments, the SIM-1 RF receive chain(s) 302a may include one or more antenna (e.g., two antennas 220a, 220b) and RF front end components of the RF resource 218. Such components may include, but are not limited to, a receiver unit, an analog to digital converter (ADC), and a digital down converter (DDC), the functions and details of which are known in the art of digital transceiver design. Similarly, the SIM-2 RF receive chain(s) 302b may include one or more (e.g., two antennas 220c, 220d) and RF front end components of the RF resource 218. In various embodiments, the RF front end components of the SIM-2 RF receive chain(s) 302b may be logically/functionally separate yet physically integrated in the RF resource 218 with the RF front end components of the SIM-1 RF receive chain(s) 302a. Similar to the SIM-1 RF receive chain(s) 302a, such components may include, but are not limited to, a receiver unit, a second analog to digital converter (ADC), and a digital down converter (DDC) (not shown). During operation in the various embodiments, the SIM-1 RF receive chains(s) 302a and SIM-2 RF receive chain(s) 302b may be adapted to receive RF signals from networks associated with either or both of the networks associated with the first and second SIMs.

Baseband processing sections 306a, 306b may represent functions of the baseband modem processor 216 associated with the SIM-1 RF receive chain(s) 302a and SIM-2 RF receive chain(s) 302b, respectively. The baseband processing sections 306a, 306b in various embodiments manage radio control functions that may include transmit functions, as well as additional receive functions, neither of which are shown. For example, transmit functions may include encoding, interleaving, and multiplexing at the symbol rate, and channelization, spreading, and modulation at the chip rate. The additional receive functions may include rake receiving, and symbol combining, and finger control at the chip rate, and demultiplexing, deinterleaving, and decoding at the symbol rate. A variety of other receive functions that are not shown may nevertheless be included in the SIM-1 RF receive chain(s) 302a and the SIM-2 RF receive chain(s) 302b, as will be understood by those of skill in the art.

In various embodiments, the baseband processing section 306a may represent functions of the baseband modem processor 216 associated with the first SIM, while the baseband processing section 306b may represent functions of the baseband modem processor 216 associated with the second SIM. Receive diversity may be enabled for each SIM when the signals received by multiple antennas 220a-220d and input to the SIM-1 RF receive chain(s) 302a and SIM-2 RF receive chain(s) 302b operate in conjunction with components providing signaling for the first and second SIMs 204a, 204b.

The various embodiments may include one or more RF switches implemented according to any of a number of suitable configurations. By changing the state of an RF switch, the path for signals received on antennas 220a-220d may be controlled. In particular, an RF switch 304 may be implemented as part of the configuration 300. In various embodiments, control of the RF switch 304 with respect to enabling and/or disabling a dual receive mode (i.e., change the path for signals processed by the SIM-1 RF receive chain(s) 302a and/or the SIM-2 RF receive chain(s) 302b) may be performed by a receive mode manager 308. For example, the diversity sharing mode discussed above may be enabled when, as a result of an inter-receive chain state change by the RF switch 304, the signal received on the SIM-1 RF receive chain(s) 302a associated with the first SIM is configured to instead operate in conjunction with components that provide signaling associated with the second SIM (i.e., baseband processing section 306b). That is, the antenna 220b of the SIM-1 receive chain(s) 302a may receive a signal which, after being processed by the RF resource 218, is passed to the baseband processing section 306b rather than to the baseband processing section 306a per typical configurations. Similarly, a signal received on the antenna 220c of the SIM-2 RF receive chain(s) 302b may, after being processed by the RF resource 218, be passed to components providing signaling associated with the first SIM (i.e., the baseband processing section 306a).

Variations in the first RF receive chain 302a and second RF receive chain 302b may exist depending on the design of the wireless device 200. In the various embodiments, the switch configurations may be applied with any numbers of antennas, RF receive chains, etc. Separate units of the baseband-modem processor 216 of the wireless device 200 may be implemented as separate structures or as separate logical units within the same structure, and may be configured to execute software including at least two protocol stacks/modem stacks associated with at least two SIMs, respectively. The SIMs and associated modem stacks may be configured to support a variety of communication services that fulfill different user requirements. Further, a particular SIM may be provisioned with information to execute different signaling procedures for accessing a domain of the core network associated with these services and for handling data thereof.

For clarity, while the techniques and embodiments described herein relate to a wireless device configured with at least one 1xRTT, TD-SCDMA, GSM, and/or WCDMA subscription, the protocol stacks in various embodiments may support any of a variety of current and/or future protocols for wireless communications. For examples, the protocol stacks in various embodiments may support networks using other radio access technologies described in 3GPP standards (e.g., Long Term Evolution (LTE), etc.), 3GPP2 standards (e.g., Evolved Data Optimized (EVDO), Ultra Mobile Broadband (UMB), etc.) and/or IEEE standards Worldwide Interoperability for Microwave Access (WiMAX), Wi-Fi, etc.).

In a MSMS device in which the SIMs are configured to implement discontinuous reception (DRX), the RF resource is typically used to support both SIMs when both are in idle mode, but one SIM at a time when at least one SIM transitions out of idle mode. Conventionally, the MSMS device will still monitor system information from, and maintain a connection with, the serving network of the second SIM by implementing idle-DRX mode on the protocol stack associated with the second SIM. That is, the RF resource periodically tunes away from communication on the first SIM in order to decode a paging channel associated with the second SIM. Such tune-aways typically degrade the data throughput performance on the active SIM.

As described, a MSMS device, such as a DSDS device, may manage collisions of idle mode communications by both SIMs and avoid tuning away from an active communication on the first SIM to enable idle mode communications by the second SIM by implementing a dual receive mode. The availability of a particular dual receive mode to be implemented in a MSMS device may be based on capabilities of the hardware associated with the RF resource (i.e., configuration of multiple antennas and/or other front end components). Selection of the dual receive mode may also depend on whether the networks associated with the first and second SIMs support both receiving on a single RF receive chain and with receive diversity. Further, selection of the dual receive mode may depend on the band filter and band groups supported by the baseband-modem processor and/or RF resource. In some embodiments, full concurrency may be available only when the bands associated with the communication on the first SIM and the paging channel on the second SIM are in separate band groups.

By implementing a dual receive mode, the impact to the data throughput of the active communication on the first SIM may be reduced in some scenarios. For example, in full concurrency mode, monitoring the paging channel for the second SIM does not degrade throughput on the first SIM. In other examples, in diversity sharing mode, the degradation of the downlink throughput on the first SIM may be reduced. In addition, the dual receive modes may cause RF coexistence events on the first and second SIMs, which may specifically impact the second SIM for decoding the paging channel in idle mode.

As described, an RF coexistence event may occur when simultaneous RF activities on the MSMS device negatively affect the performance of one another or the general performance of the MSMS device. An example RF coexistence event may be receiver desense in which transmission of signals from the MSMS device degrades the receiving of signals from another network (i.e., through a different RF receive chain, such as a diversity chain being utilized by another SIM). Another example RF coexistence event may be adjacent channel interference in which RF activity on one or more RF chains associated with one SIM overlaps with the spectrum for RF activity on one or more RF chains associated with another SIM (e.g., during use of the RF resource for primary and diversity chains associated with both the first and second SIMs). These RF coexistence events may impact activity associated with both SIMs. In particular, such coexistence events may be harmful to the paging performance on the idle mode (e.g., second) SIM.

Further, various scenarios other than coexistence may degrade performance on the idle mode SIM when operating in the dual receive mode. Such problems may include spur issues that are unexpected or not mitigated properly, poor channel conditions that make receive diversity necessary when the diversity is unavailable (e.g., in diversity sharing mode), poor performance on the antenna that tunes away for the paging cycle on the idle mode SIM (e.g., in diversity sharing mode), etc. In various embodiments, a fallback mode may be employed to mitigate potential RF coexistence events and/or other problems to the paging performance on a MSMS device due to receiving signals from multiple different networks. Specifically, in various embodiments, the MSMS device may dynamically switch between the dual receive mode and a fallback mode when degradation to paging performance on the idle mode (e.g., second) SIM reaches a certain level. In various embodiments, the fallback mode may involve disabling the dual receive mode on the RF resource, causing the MSMS device to revert to time-sharing on the RF resource. To perform idle mode communications on the second SIM (e.g., receive the paging channel from the serving cell associated with the second SIM), in the fallback mode the RF resource may temporarily tune away from the active communication on the first SIM.

In various embodiments, implementing the fallback mode involves disabling RF front end components associated with the RF receive chain(s) for the first SIM (e.g., one or more antenna) and activating RF front end components (e.g., one or more antenna) associated with RF receive chain(s) for the second SIM. In this manner, the RF resource is not receiving signals from more than one network at the same time, thereby eliminating RF coexistence issues. In various embodiments, the fallback scheme may involve various dynamic determinations on a receive mode manager of the MSMS device. In various embodiments, fallback mode may be triggered when performance on the idle mode SIM (e.g., second SIM) is degraded to a certain amount. Such degradation may be evaluated based on measuring one or more performance metrics, depending on the radio access technology being used on the second SIM. In some embodiments, the performance metrics measured to trigger the fallback mode may include measurements for conditions other than dual receive mode that may be causing the performance degradation.

Since the MSMS device may be configured to maximize the amount of time spent in dual receive mode, the MSMS device may exit the fallback mode and re-enter the dual receive mode as soon as performance on the idle mode SIM improves by a certain amount. Additionally, for the same reasons the MSMS device may exit the fallback mode and re-enter the dual receive mode if the fallback mode is not shown to be improving performance, such as within a certain amount of time. Such failure to improve performance may indicate, for example, that the performance degradation is not caused by coexistence or other problems based on dual receive mode.

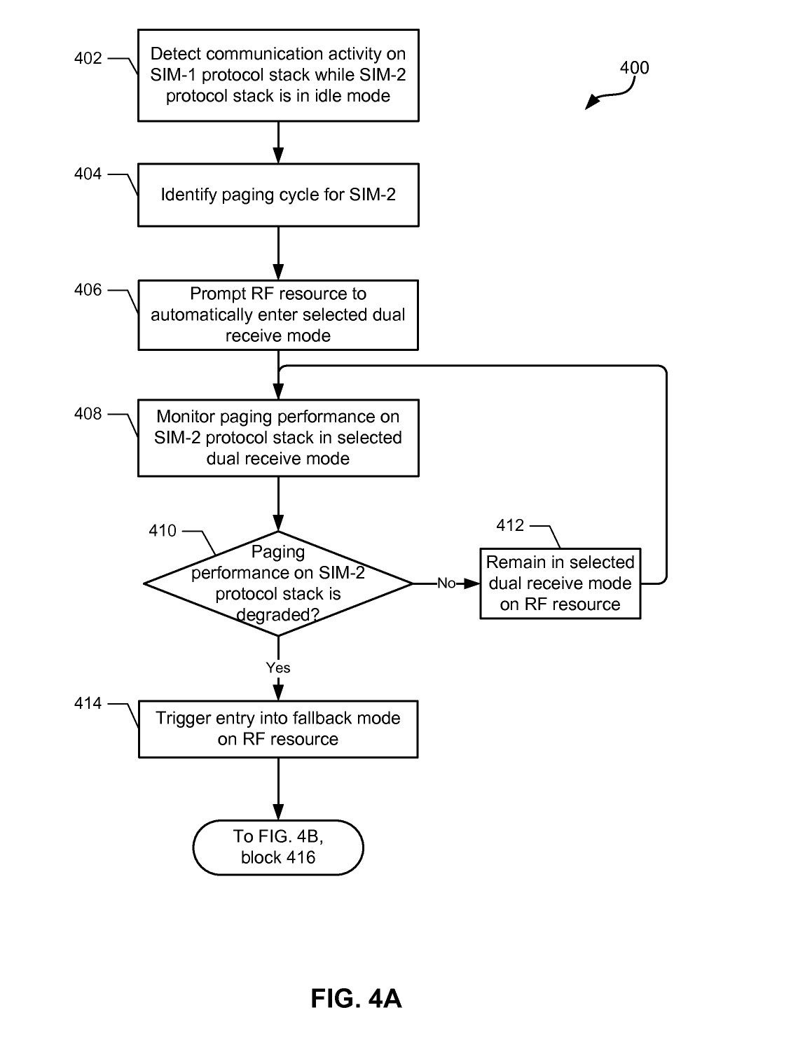

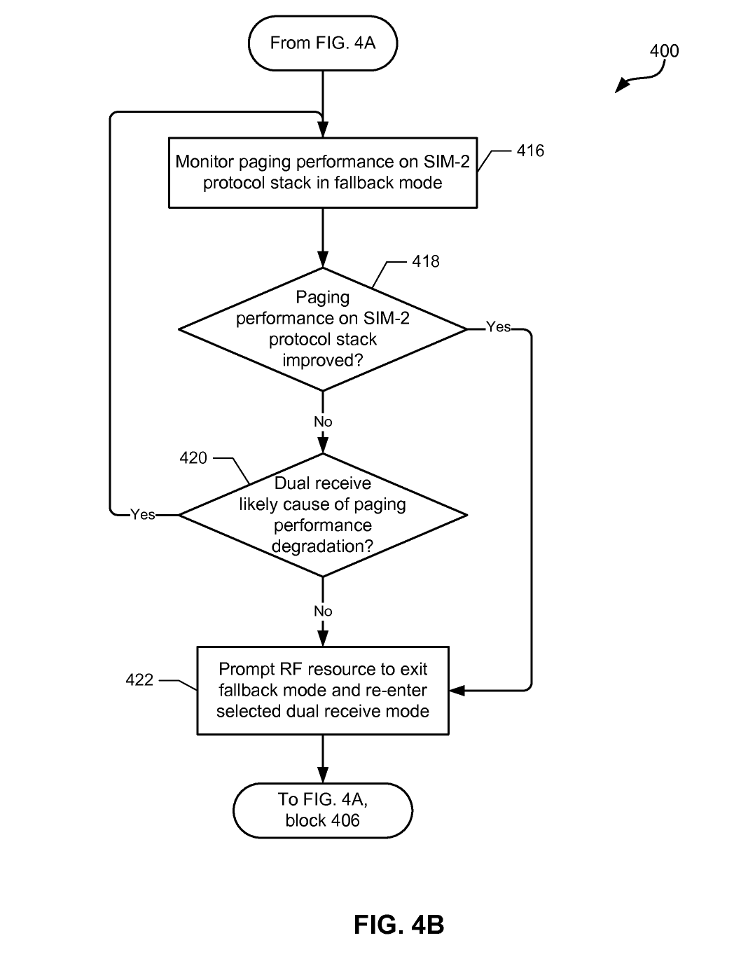

FIGS. 4A and 4B illustrate a method 400 of dynamically managing the receive mode for an RF resource in an MSMS device based on current conditions (i.e., RF coexistence events and/or other events) according to some embodiments. With reference to FIGS. 1-4B, the operations of the method 400 may be implemented in the receive mode manager 308 by one or more processors of the wireless device 200, such as the general purpose processor 206 and/or baseband modem processor(s) 216, or a separate controller (not shown) that may be coupled to the memory 214 and to the baseband modem processor(s) 216.

While the descriptions of the various embodiments address managing receive mode switching as among two SIMs for use of RF receive chains associated with one RF resource, the various embodiment processes may be implemented to manage receive mode switching between more than two SIMs and/or RF resources of more than two RF resources and/or SIMs. For example, a receive mode manager may be configured to switch between dual receive modes and a fallback hybrid receive mode among three SIMs for use of RF receive chains associated with two shared RF resources, among four SIMs for use of receive chains associated with three shared RF resources, etc. In various embodiments, the receive mode manager may output control signals to the protocol stacks associated with the first and second SIMs, and/or to one or more switch associated with the RF resource 218 and/or antenna(s) 220.

The references to the first SIM (“SIM-1”) and associated RF chain(s) (first SIM RF chain(s)) and the second SIM (“SIM-2”) and associated RF chain(s) (second SIM RF chain(s)) are arbitrary and used merely for the purposes of describing the embodiments. The wireless device processor may assign any indicator, name, or other designation to differentiate the SIMs, associated protocol stacks, and receive components resources. Further, embodiment methods apply the same regardless of which SIM is benefiting from the dual receive mode or fallback hybrid receive mode. For example, in one call a protocol stack associated with the second SIM may be in idle mode and require tune-aways in order to monitor a paging channel in a particular network, while in the next call, a protocol stack associated with the first SIM may be in idle mode and require tune-aways in order to monitor a paging channel in a particular network. While dynamic receive mode switching depends on the particular radio access technologies associated with each SIM and rules configured to be implemented by the receive mode manager, a general algorithm for receive mode management may proceed according to the method 400.

In block 402 (FIG. 4A), the wireless device processor may detect a communication activity on a first SIM (“SIM-1”) while a second SIM (“SIM-2”) is in idle mode. In various embodiments, such detection may occur while a shared RF resource is operating in a diversity mode. For example, such detection may be based on idle mode communications (e.g., an idle mode paging cycle) of the first SIM that collide with idle mode communications of the second SIM and/or based on an active communication on the first SIM which collides with idle mode communications of the second SIM. In the latter circumstance, the device processor may detect RF activity on a protocol stack associated with the first SIM, and that the protocol stack associated with the second SIM is in idle mode.

In block 404, the wireless device processor may identify a paging cycle for the second SIM in the idle mode. In some embodiments, such identification may be calculated based on the radio access technology of the network for the second SIM and signaling indicating a wake-up period of the power-saving mode (e.g., DRX) cycle for the second SIM protocol stack. In some embodiments, the wireless device processor may query the second SIM protocol stack to identify the paging cycle set by the second SIM network.

In block 406, the wireless device processor may prompt the RF resource to enter a selected dual receive mode (i.e., to enable the wireless device to attempt the required RF activity on the second SIM). As described, the selected dual receive mode may depend on a number of factors specific to the particular wireless device and the SIMs. In some embodiments, such factors may include the capabilities of the network and RF resource, as well as the RF frequency band groups used in the networks associated with the first and second SIMs.

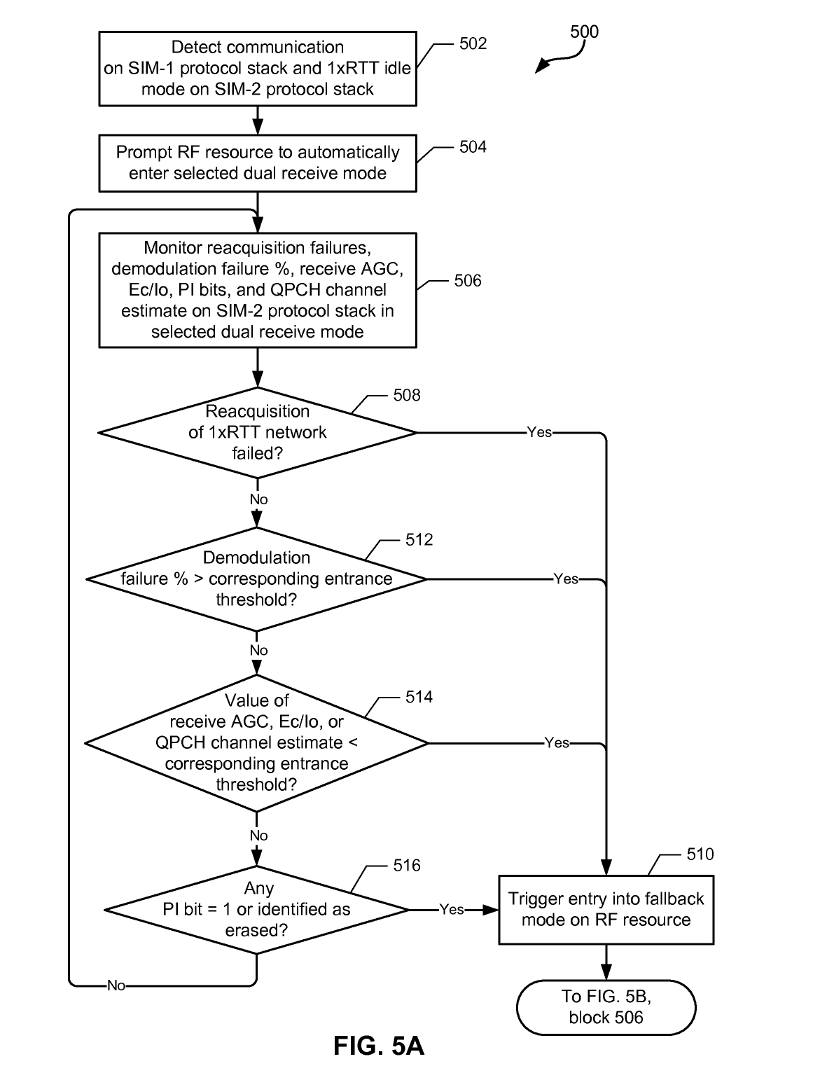

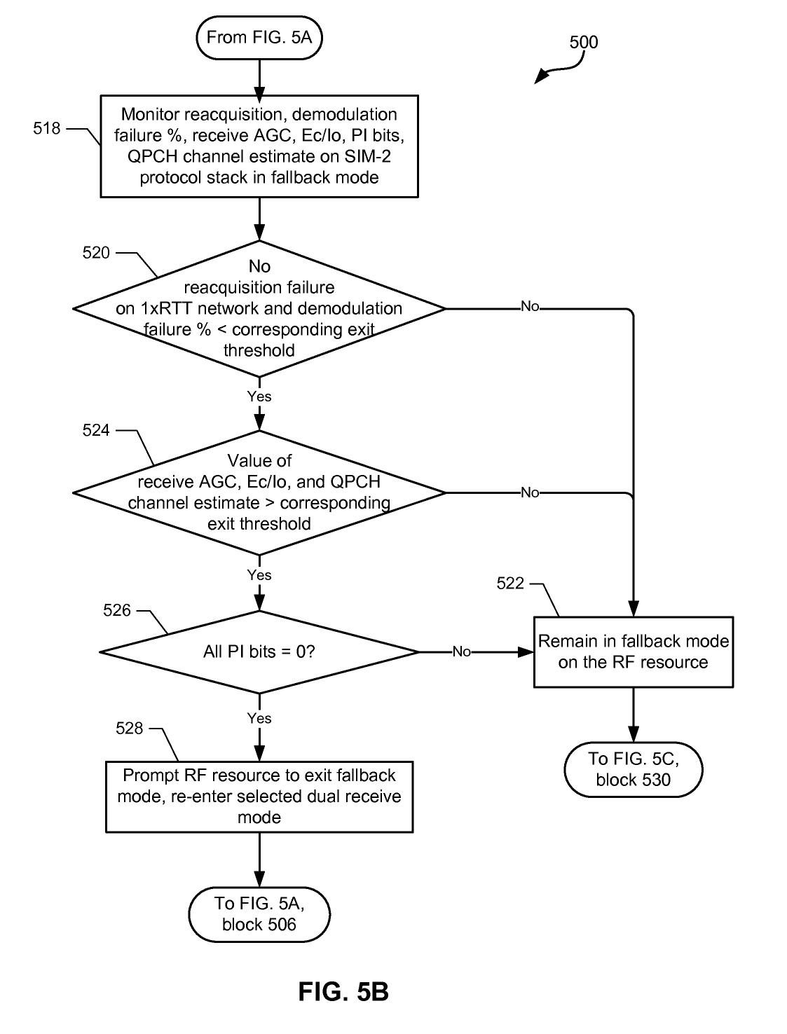

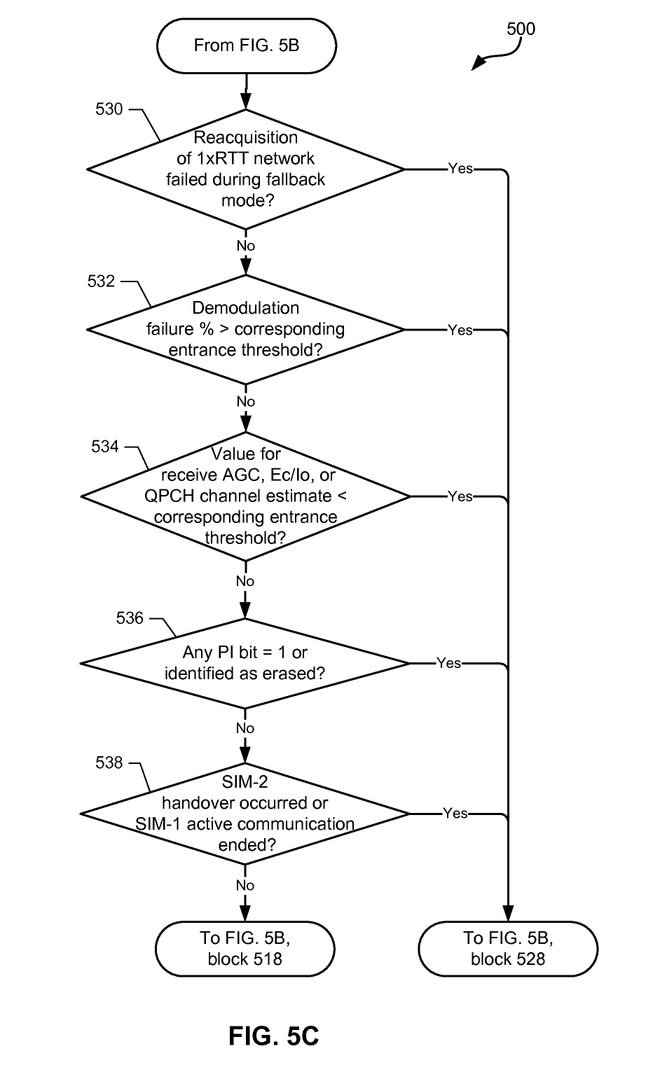

In block 408, while in the selected dual receiver mode, the wireless device processor may monitor the paging performance on the protocol stack associated with the second SIM. Such monitoring may involve any of a number of metrics depending on the radio access technology of the network acquired by the second SIM, as described with reference to FIGS. 5A-8.

Returning to FIGS. 1-4, in determination block 410, the wireless device processor may determine whether paging performance on the protocol stack associated with the second SIM is degraded. In response to determining that the paging performance on the protocol stack associated with the second SIM is not degraded (i.e., determination block 410=“No”), the wireless device processor may remain in the selected dual receive mode on the RF resource in block 408. In response to determining that the paging performance on the protocol stack associated with the second SIM is degraded (i.e., determination block 410=“Yes”), the wireless device processor may trigger entry into fallback mode on the RF resource in block 414.

In block 416 (FIG. 4B), the wireless device processor may monitor the paging performance on the protocol stack associated with the second SIM in the fallback mode. Such monitoring may involve any of a number of metrics, which may be the same as or different from those used to measure performance in the selected dual receive mode (i.e., in block 408 of FIG. 4A). In determination block 418, the wireless device processor may determine whether the paging performance on the protocol stack associated with the second SIM has improved. Such determination of improvement may be based on measuring one or more performance metric as described, which may be evaluated periodically and/or after expiration of a predetermined amount of time.

In response to determining that the paging performance on the protocol stack associated with the second SIM has not improved (i.e., determination block 418=“No”), the wireless device processor may determine whether the selected dual receive mode is likely causing the paging performance degradation in determination block 420. Such determination of causation may be an estimate based on measurements associated with actual coexistence, with additional potential causes of degradation for the second SIM (i.e., signal strength, network-side issues, etc.). In response to determining that the selected dual receive mode is likely the cause of the paging performance degradation (e.g., determination block 420=“Yes”), the wireless device processor, while in the fallback mode, may continue monitoring the paging performance on the protocol stack for the second SIM in block 416.

In response to determining that the paging performance on the protocol stack associated with the second SIM has improved (i.e., determination block 418=“Yes”), or that the selected dual receive mode is not likely to be causing the paging performance degradation (e.g., determination block 420=“No”), the wireless device processor may prompt the RF resource to exit the fallback mode and re-enter the selected dual receive mode in block 422. Again in the selected dual receive mode, the wireless device processor may monitor paging performance on the protocol stack associated with the second SIM in block 408 (FIG. 4A).

As described, the dynamic management of receive modes by the receive mode manager (or the processor executing the receive mode manager) may be based on the particular radio access technologies enabled by each SIM and the rules (i.e., fallback scheme) with which the receive mode manager is configured. Examples of the receive mode management with respect to specific radio access technologies are discussed below with respect to FIGS. 5A-8.

FIGS. 5A-5C illustrate a method 500 according to some embodiments that may be implemented in a wireless device (e.g., 102, 200 in FIGS. 1-2), such as an MSMS device configured with a first SIM (SIM-1) that supports one or more radio access standard, and with a second SIM (SIM-2) that supports at least one different radio access standard. For example, in some embodiments the second SIM may support a CDMA protocol access standard, such as described in EIA/TIA/IS-2000 Rel. 0, A (“1xRTT”). While described with reference to a 1xRTT network, the method 500 shown in FIGS. 5A-5C may be implemented for any of a number of radio access technologies.

With reference to FIGS. 1-5A, in block 502 of method 500, the wireless device processor may detect a communication on the protocol stack associated with the first SIM and detect an idle mode for monitoring a 1xRTT network on the protocol stack associated with the second SIM. In block 504, the wireless device processor may prompt the RF resource to enter a selected dual receive mode on the RF resource. In various embodiments, the wireless device processor may be configured to employ, by default, dual receive modes over the legacy time-sharing mode in order to obtain the best quality/throughput on each SIM. Further, in various embodiments, selecting a dual receive mode may involve accessing default settings and/or capabilities associated with the baseband-modem processor, RF resource, and/or front end receive components, and the first and second SIMs.

In block 506, the wireless device processor may monitor various performance metrics on the protocol stack associated with the second SIM while in the selected dual receive mode. For example, a monitored performance metric may include any failures to reacquire the 1xRTT network during page decode periods. Another monitored performance metric may be a percentage of failed attempts to demodulate the signal received on the paging channel (i.e., the demodulation failure percentage (%)). Another monitored performance metric may be a percentage of automatic gain control (AGC) by the one or more RF receive chains used for the second SIM in the selected dual receive mode. In various embodiments, AGC may be needed to regulate input into the ADC in order to meet the required signal-to-noise ratio (SNR) for proper decoding. Another monitored performance metric may be a ratio of the received power of the pilot signal to the overall signal noise (Ec/Io), which measures quality of pilot signal.

Other monitored performance metrics may involve the quick paging channel (QPCH). In various embodiments, the quick paging channel includes quick paging bits (also called paging indicator (PI) bits) that are set to indicate a page in the general paging message of the paging channel. In some embodiments, each PI bit may be identified as “on” (i.e., decoded value of “1”), “off” (i.e., decoded value of “0”), or an erasure, which indicates that the PI bit is too unreliable to be decoded as either a value of “1” or “0.” When both PI bits in the QPCH have a value of zero (i.e., PI bits=0), the subsequent general paging message need not be demodulated by a wireless device monitoring the paging channel. A QPCH channel condition, which indicates the ability to reliably receive the signals in the serving network, may be estimated based on the strength of the QPCH signal carrying the PI bits.

In various embodiments, satisfaction of any of a variety of conditions or entrance thresholds tied to the monitored performance metrics in block 506 may trigger the fallback mode on the RF resource. For example, in determination block 508, the wireless device processor may determine whether a failure to reacquire the 1xRTT network has occurred. In response to determining that a failure to reacquire the 1xRTT network has occurred (i.e., determination block 508=“Yes”), the wireless device processor may trigger entry into the fallback mode on the RF resource in block 510. In various embodiments, entering the fallback mode on the RF resource may involve sending a request to the Mobile Switching Center (MSC) for the 1xRTT network.

In response to determining that no failure to reacquire the 1xRTT network occurred (i.e., determination block 508=“No”), the wireless device processor may determine whether the monitored demodulation failure percentage is greater than an entrance threshold for the demodulation failure in determination block 512. In various embodiments, the entrance threshold for the demodulation failure may be predetermined based on one or more settings associated with the 1xRTT network (e.g., a baseline failure threshold that ordinarily expected for the particular 1xRTT network). In response to determining that the monitored demodulation failure percentage is greater than the entrance threshold (i.e., determination block 512=“Yes”), the wireless device processor may enter the fallback mode on the RF resource in block 510.

In response to determining that the monitored demodulation failure percentage is not greater than the entrance threshold (i.e., determination block 512=“No”), the wireless device processor may determine whether any monitored value for the receive AGC, Ec/Io, and QPCH channel estimate is less than a corresponding entrance threshold for the receive AGC, Ec/Io, and QPCH channel estimate in determination block 514. In various embodiments, these entrance thresholds may be predetermined based on settings or default values associated with the 1xRTT network. In response to determining that the monitored value for one or more of the receive AGC, Ec/Io, and QPCH channel estimate is less than the corresponding entrance threshold (i.e., determination block 514=“Yes”), the wireless device processor may enter the fallback mode on the RF resource in block 510.

In response to determining that none of the monitored value for the receive AGC, Ec/Io, or QPCH channel estimate is less than the corresponding entrance threshold (i.e., determination block 514=“No”), the wireless device processor may determine whether any PI bit is identified as erased or as set to a value of “1” (i.e., indicating a general paging message to be decoded) in determination block 516. In response to determining that no PI bit is identified as either erased or set to a value of “1” (i.e., determination block 516=“No”), the wireless device processor in the selected dual receive mode may monitor the performance metrics for the protocol stack of the second SIM in block 506. In response to determining that a PI bit is identified as erased and/or a PI bit is set to a value of “1” (i.e., determination block 516=“Yes”), the wireless device processor may enter the fallback mode on the RF resource in block 510.

In block 518 (FIG. 5B), the wireless device processor may monitor various performance metrics on the protocol stack associated with the second SIM while in the fallback mode. Similar to selected dual receive mode (e.g., block 506 in FIG. 5A) such performance metrics may include, for example, reacquisition failures, a demodulation failure percentage, a receive AGC value, an Ec/Io value, PI bit values and erasures, and QPCH channel estimate value. In various embodiments, satisfaction of a variety of conditions or exit thresholds indicating improvement of paging performance on the protocol stack associated with the second SIM may trigger exiting the fallback mode and re-entering the selected dual receive mode on the RF resource. In various embodiments, such exit thresholds may be predetermined based on one or more settings associated with the 1xRTT network.

In determination block 520, the wireless device processor may determine whether there has been no failure to reacquire the 1xRTT network during the fallback mode, and the monitored demodulation failure percentage is less than the corresponding exit threshold. In response to determining that any failure to reacquire the 1xRTT network has occurred in fallback mode and/or that the monitored demodulation failure percentage is not less than the corresponding exit threshold (i.e., determination block 520=“No”), the wireless device processor may remain in the fallback mode on the RF resource in block 522.

In response to determining that no failure to reacquire the 1xRTT network has occurred in fallback mode and that the monitored demodulation failure percentage is less than the corresponding exit threshold (i.e., determination block 520=“Yes”), the wireless device processor may determine whether the monitored value for each of the receive AGC, Ec/Io, and QPCH channel estimate is greater than its corresponding exit thresholds in determination block 524. In response to determining that the monitored value for any of the receive AGC, the Ec/Io, and the QPCH channel estimate is not greater than its corresponding exit threshold (i.e., determination block 524=“No”), the wireless device processor may remain in the fallback mode on the RF resource in block 522.

In response to determining that the monitored values for each of the receive AGC, Ec/Io, and QPCH channel estimate is greater than its corresponding exit thresholds (i.e., determination block 524=“Yes”), the wireless device processor may determine whether all of the PI bits were identified as set to a value of “0” (i.e., indicating no paging message, and no bit that could not be decoded) in determination block 526. In response to determining that all of the PI bits were identified as set to a value of “0,” (i.e., determination block 526=“Yes”), the wireless device processor may prompt the RF resource to exit the fallback mode and re-enter the selected dual receive mode in block 528. In various embodiments, exiting the fallback mode may involve sending a de-registration message to the MSC of the 1xRTT network. The wireless device processor may return to monitoring the performance metrics in the dual receive mode for the protocol stack of the second SIM in block 506 (FIG. 5A).

In response to determining that one or more PI bit was not identified as set to a value of “0” (i.e., determination block 526=“No”), the wireless device processor may remain in the fallback mode on the RF resource in block 522.

In various embodiments, when the conditions or entrance thresholds indicating performance degradation on the protocol stack associated with the second SIM remain satisfied in the fallback mode, such performance degradation may be not caused by coexistence or other dual receive problems. As a result, the RF resource may exit the fallback mode in situations in which doing so is not useful for improving performance. To address this potential scenario, in determination block 530 (FIG. 5C), the wireless device processor may determine whether any failure to reacquire the 1xRTT network occurred during the fallback mode. In response to determining that a failure to reacquire the 1xRTT network occurred during the fallback mode (i.e., determination block 530=“Yes”), the wireless device processor may prompt the RF resource to exit the fallback mode and re-enter the selected dual receive mode on the RF resource in block 528 (FIG. 5B).

In response to determining that no failure to reacquire the 1xRTT network occurred during the fallback mode (i.e., determination block 530=“No”), the wireless device processor may determine whether the monitored demodulation failure percentage is greater than the corresponding entrance threshold in determination block 532. In response to determining that the demodulation failure percentage is greater than the corresponding entrance threshold (i.e., determination block 532=“Yes”), the wireless device processor may prompt the RF resource to exit the fallback mode and re-enter the selected dual receive mode on the RF resource in block 528 (FIG. 5B).

In response to determining that the demodulation failure percentage is not greater than the corresponding entrance threshold (i.e., determination block 532=“No”), the wireless device processor may determine whether the monitored value for any of the receive AGC, Ec/Io, and QPCH channel estimate is less than the corresponding entrance threshold for the receive AGC, the Ec/Io, and the QPCH channel estimate in determination block 534. In response to determining that the monitored value for one or more of the receive AGC, Ec/Io, and QPCH channel estimate is less than the corresponding entrance threshold (i.e., determination block 534=“Yes”), the wireless device processor may prompt the RF resource to exit the fallback mode and re-enter the selected dual receive mode on the RF resource in block 528 (FIG. 5B).

In response to determining that the none of the monitored values for the receive AGC, Ec/Io, and QPCH channel estimate is less than the corresponding entrance threshold (i.e., determination block 534=“No”), the wireless device processor may determine whether any PI bit is identified as being erased or as being set to a value of “1” in determination block 536. In response to determining that a PI bit is identified as being erased and/or a PI bit is identified as being set to a value of “1” (i.e., determination block 536=“Yes”), the wireless device processor may prompt the RF resource to exit the fallback mode and re-enter the selected dual receive mode on the RF resource in block 528 (FIG. 5B).

In response to determining that no PI bit is identified as being erased or as being set to a value of “1” (i.e., determination block 536=“No”), the wireless device processor may determine whether the idle mode processes for the second SIM have been handed over to a new cell in the 1xRTT network (i.e., a handover has occurred) and/or the active communication associated with the first SIM has ended, in determination block 538. In response to determining that a handover has occurred for the second SIM and/or that the active communication associated with the first SIM has ended (i.e., determination block 538=“Yes”), the wireless device processor may prompt the RF resource to exit the fallback mode and re-enter the selected dual receive mode on the RF resource in block 528 (FIG. 5B). In response to determining that no handover occurred for the second SIM and that the active communication on the first SIM is still ongoing (i.e., determination block 538=“No”), the wireless device processor may prompt the RF resource to remain in the fallback mode in block 518 (FIG. 5B).

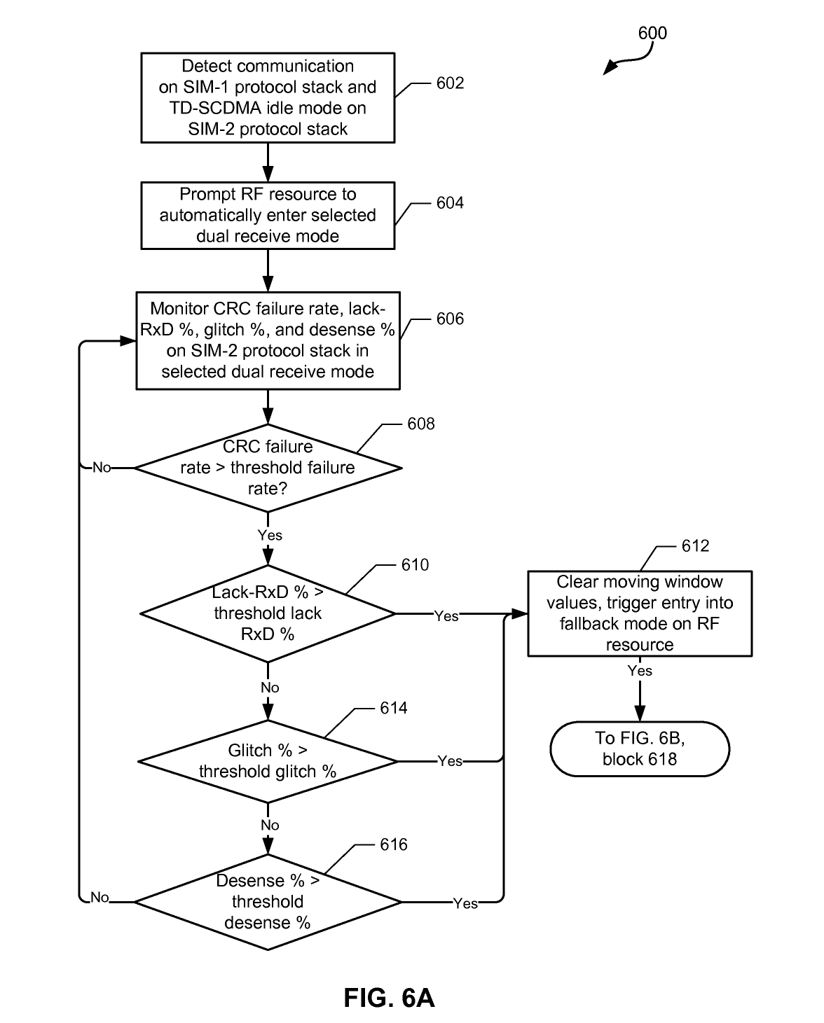

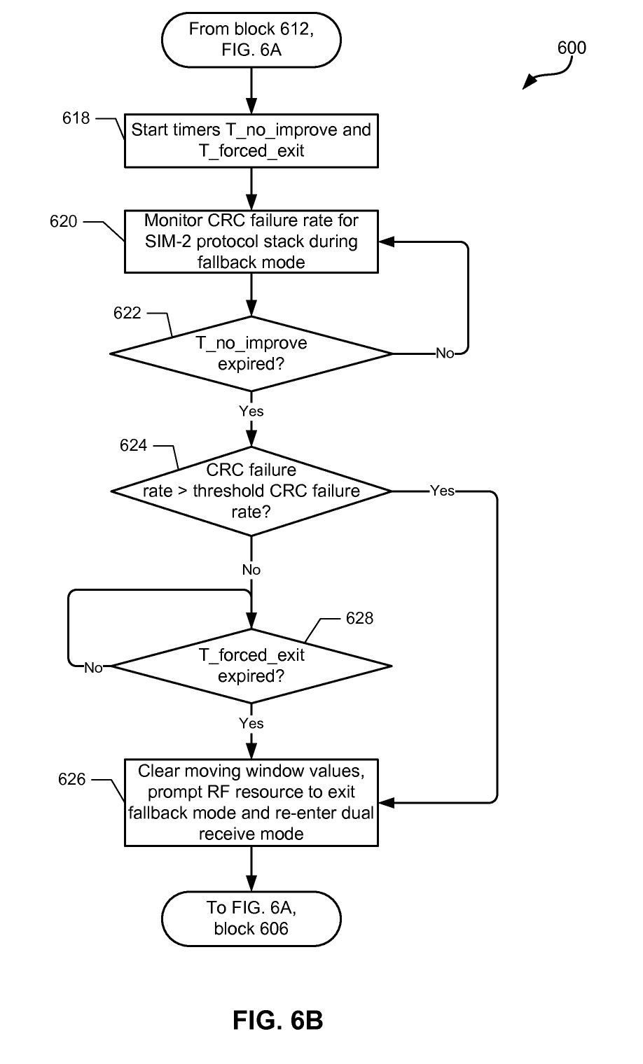

FIGS. 6A and 6B illustrate a method 600 according to embodiments that may be implemented in a wireless device (e.g., the wireless device 200 in FIG. 2), such as a MSMS device configured with a first SIM that supports one or more radio access standard, and with a second SIM that supports at least one different radio access standard, such as a TD-SCDMA protocol access standard. In some embodiments, specific events or conditions other than those due to RF coexistence may affect performance during idle mode on a TD-SCDMA network based on an idle mode receive diversity state machine Such idle mode receive diversity state machine may indicate whether receive diversity should be turned “on” or “off” for a next wake-up period on the idle mode SIM. The state transitions between on and off in idle mode may depend on the long-term signal to interference ratio (SIR) value, the received signal code power (RSCP) value, and/or the cyclic redundancy check (CRC) codes returned by the PCH decoding. Some dual receive modes, such as the diversity sharing mode, may prevent the implementing receive diversity. Therefore, if in the diversity sharing mode and the idle mode receive diversity state machine indicates that receive diversity should be turned on for decoding the paging channel in the TD-SCDMA network, the protocol stack associated with the idle mode SIM may be unable to follow the state indication, degrading performance.

While described with reference to a TD-SCDMA network, the method 600 illustrated in FIGS. 6A and 6B may be implemented for any of a number of radio access technologies. With reference to FIGS. 1-6A, in block 602 of the method 600, the wireless device processor may detect a communication on the protocol stack associated with the first SIM, and an idle mode in a TD-SCDMA network on the protocol stack associated with the second SIM. In block 604, the wireless device processor may prompt the RF resource to enter a selected dual receive mode on the RF resource. As described, the wireless device processor may be configured to employ, by default, dual receive modes over the legacy time-sharing mode in order to obtain the best quality/throughput on each SIM. Further, as described, the selected dual receive mode may involve accessing default settings and/or capabilities associated with the baseband-modem processor, RF resource, and/or front end receive components.

In block 606, the wireless device processor may monitor various performance metrics on the protocol stack associated with the second SIM while in the selected dual receive mode. In various embodiments, the performance metrics may be monitored within a moving window of a particular duration T_window (e.g., the time for completion of 50 power-saving mode (e.g., DRX) cycles). For example, the monitored performance metrics may include an idle mode CRC failure rate, a percentage timeslots associated with the TD-SCDMA network that are experiencing glitch (glitch %), and a percentage of timeslots associated with the TD-SCDMA network that are experiencing desense (desense %). The monitored performance metrics may also include a percentage, in a TD-SCDMA sub-frame, of “on” indications from the idle mode receive diversity state machine that cannot be followed (i.e., lack-RxD %).

In determination block 608, the wireless device processor may determine whether the monitored idle mode CRC failure rate is greater than a threshold CRC failure rate. For example, the threshold CRC failure rate may be 5%, where the typical CRC failure rate for a single SIM is around 1%. In response to determining that the CRC failure rate is not greater than the threshold CRC failure rate (i.e., determination block 608=“No”), the wireless device processor may continue monitoring the performance metrics for the protocol stack associated with the second SIM in block 606.

In response to determining that the CRC failure rate is greater than the threshold CRC failure rate (i.e., determination block 608—“Yes”), the wireless device may determine whether any of a series of other thresholds related to the monitored performance metrics are satisfied in order to trigger the fallback mode. For example, in determination block 610 the wireless device processor may determine whether the lack-RxD % is greater than a threshold lack-RxD %, which, for example, may be 10%. In response to determining that the lack-RxD % is greater than the threshold lack-RxD % (i.e., determination block 610=“Yes”), the wireless device processor may clear the moving window values and trigger entry into the fallback mode on the RF resource in block 612.

In response to determining that the lack-RxD % is not greater than the threshold lack-RxD % (i.e., determination block 610=“No”), the wireless device processor may determine whether the monitored glitch % is greater than a threshold glitch % in determination block 614. In various embodiments, the threshold glitch % may be set based on a baseline glitch % associated with the TD-SCDMA network. In response to determining that the glitch % is greater than the threshold glitch % (i.e., determination block 614=“Yes”), the wireless device processor may clear the moving window values and enter the fallback mode on the RF resource in block 612.

In response to determining that the glitch % is not greater than the threshold glitch % (i.e., determination block 614=“No”), the wireless device processor may determine whether the monitored desense % is greater than a threshold desense % in determination block 616. In various embodiments, the threshold desense % may be set, for example, based on a baseline desense % associated with the idle mode SIM (e.g., second SIM) and/or the RF resource capabilities. In response to determining that the monitored desense % is not greater than a threshold desense % (i.e., determination block 616=“No”), the wireless device processor may monitor the performance metrics on the protocol stack associated with the second SIM while in the selected dual receive mode in block 606. In response to determining that the monitored desense % is greater than a threshold desense % (i.e., determination block 616=“Yes”), the wireless device processor may clear the moving window values and enter the fallback mode on the RF resource in block 612.

Referring to FIG. 6B, having cleared the moving window values in block 612, the wireless device processor may start a timer T_no_improve and a timer T_forced_exit in block 618. For example, the duration of T_no_improve may be set to two times the T_window, and the duration of T_forced_exit may be set to 10 times the T_window. In block 620, the wireless device processor may monitor the idle mode CRC failure rate for the protocol stack associated with the second SIM while in the fallback mode.

In determination block 622, the wireless device processor may determine whether T_no_improve has expired. So long as T_no_improve has not expired (i.e., determination block 622=“No”), the wireless device processor may continue to monitor the idle mode CRC failure rate for the protocols tack associated with the second SIM in block 622. In response to determining that T_no_improve has expired (i.e., determination block 622=“Yes”), the wireless device processor may determine whether the monitored idle mode CRC failure rate is greater than the threshold CRC failure rate in determination block 624. In response to determining that the monitored CRC failure rate is greater than the threshold CRC failure rate (i.e., determination block 624=“Yes”), the wireless device processor may clear the moving window values (i.e., monitored CRC rate in fallback mode), and prompt the RF resource to exit the fallback mode and re-enter the selected dual receive mode in block 626.

In response to determining that the monitored idle mode CRC failure rate is not greater than the threshold CRC failure rate (i.e., determination block 624=“No”), the wireless device processor may determine whether T_forced_exit has expired in determination block 628. So long as T_forced_exit has not expired (i.e., determination block 628=“No”), the wireless device processor may repeat the determination of whether T_forced_exit has expired in determination block 628. In response to determining that T_forced_exit has expired (i.e., determination block 628=“Yes”), the wireless device processor may clear the moving window values (i.e., monitored CRC rate in fallback mode), and prompt the RF resource to exit the fallback mode and re-enter the selected dual receive mode in block 626. The wireless device processor may return to monitoring various performance metrics on the protocol stack associated with the second SIM while in the selected dual receive mode in block 606 (FIG. 6A).

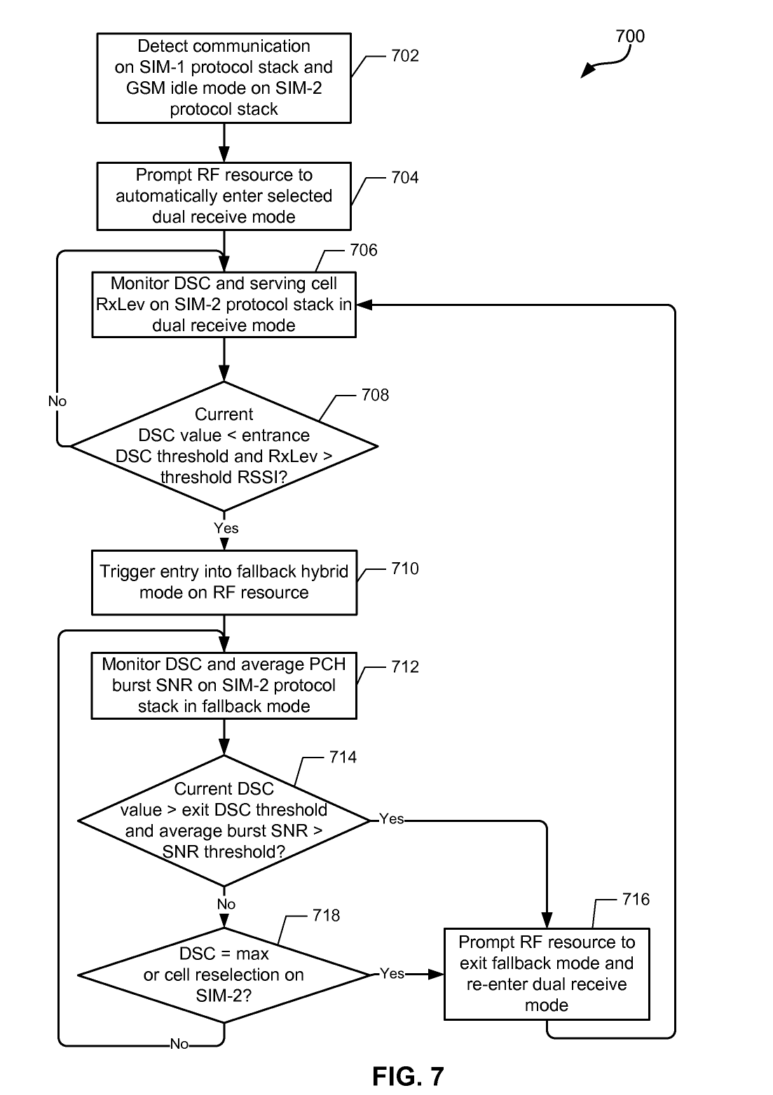

FIG. 7 illustrates a method 700 according to some embodiments that may be implemented in a wireless device (e.g., the wireless device 200 in FIG. 2), such as a MSMS device configured with a first SIM (“SIM-1”) that supports one or more radio access standard, and with a second SIM (“SIM-2”) that supports at least one different radio access standard, such as a GSM access standard. While described with reference to a GSM network, the embodiments described with respect to FIG. 7 may be implemented for any of a number of radio access technologies. With reference to FIGS. 1-7, in block 702 of the method 700, the wireless device processor may detect a communication on the protocol stack associated with the first SIM, and an idle mode in a GSM network on the protocol stack associated with the second SIM. In block 704, the wireless device processor may prompt the RF resource to enter a selected dual receive mode. As described, the wireless device processor may be configured to employ, by default, dual receive modes over the legacy time-sharing mode in order to obtain the best quality/throughput on each SIM. Further as described, the selected dual receive mode may involve accessing default settings and/or capabilities associated with the baseband-modem processor, RF resource, and/or front end receive components.

In block 706, the wireless device processor may monitor various performance metrics on the protocol stack associated with the second SIM while in the selected dual receive mode. In various embodiments, such performance metrics may include a current downlink signaling failure counter (DSC) value, which provides cumulative information about success and failure in receiving downlink packets. Specifically, in the GSM network, successfully receiving a signaling packet on a broadcasting channel (e.g., paging channel) causes the current DSC value to be incremented by one, while losing the signaling packet causes the current DSC value to be decremented by four. In various embodiments, the current DSC value is not permitted to go above a maximum DSC value. Another performance metric may include a received signal strength parameter (RxLev) for the serving cell in the GSM network.

In determination block 708, the wireless device processor may determine whether the current DSC value is less than an entrance DSC threshold value, indicating poor paging performance on the protocol stack associated with the second SIM, and the serving cell RxLev value is greater than a threshold received signal strength indicator (RSSI), indicating good radio conditions in the GSM network. That is, by satisfying both criteria, the wireless device processor rules out poor paging performance occurrences that are due to poor radio conditions as opposed to problems in the selected dual receive mode. In some embodiments, the entrance DSC threshold value may be a percentage of the number of PCH bursts attempted to be received from the serving cell in the GSM network, such as 50%, while the threshold RSSI may be set to a default −90 dBm. In response to determining that either the current DSC value is not less than the entrance DSC threshold value or the serving cell RxLev value is not greater than the threshold RSSI (i.e., determination block 708=“No”), the wireless device processor may continue to monitor the performance metrics for the protocol stack associated with the second SIM in the selected dual receive mode in block 706.

In response to determining that the current DSC value is less than the entrance DSC threshold value and the serving cell RxLev value is greater than the threshold RSSI (i.e., determination block 708=“Yes”), the wireless device processor may trigger entry into the fallback mode on the RF resource in block 710. In some embodiments, the fallback mode in the GSM network may involve re-enabling the selected dual receive mode for one out of every four page decode periods. In block 712, the wireless device processor may monitor the current DSC value and average paging channel (PCH) burst signal-to-noise ratio (SNR) for the protocol stack of the second SIM in the fallback mode.

In determination block 714, the wireless device processor may determine whether the current DSC value is greater than an exit DSC threshold value and the average PCH burst SNR is less than a threshold SNR. In some embodiments, the exit DSC threshold value may be 40% of the number of PCH bursts attempted to be received from the serving cell in the GSM network, while the threshold SNR may be set to a default of 6 dB. In response to determining that the current DSC value is greater than the exit DSC threshold value and the average PCH burst SNR is less than the threshold SNR (i.e., determination block 714=“Yes”), the wireless device processor may prompt the RF resource to exit the fallback mode and re-enter the selected dual receive mode in block 716.

In response to determining that the current DSC value is not greater than the exit DSC threshold value and/or the average PCH burst SNR is not less than the threshold SNR (i.e., determination block 714=“No”), the wireless device processor may determine whether the current DSC value has reached the maximum DSC value and/or a cell reselection has occurred for the second SIM in determination block 718. In response to determining that the current DSC value has not reached the maximum DSC value and there has not been a cell reselection on the second SIM (i.e., determination block 718=“No”), the wireless device processor may continue monitoring performance metrics in the fallback mode (i.e., current DSC and average PCH burst SNR) in block 712. In response to determining that the current DSC value is equal to the maximum DSC value and/or a cell reselection has occurred for the second SIM (i.e., determination block 718=“Yes”), the wireless device processor may prompt the RF resource to exit the fallback mode and re-enter the selected dual receive mode in block 716. The wireless device processor may return to monitoring the performance metrics (e.g., current DSC and RxLev values) for the protocol stack associated with the second SIM while in the selected dual receive mode in block 706.

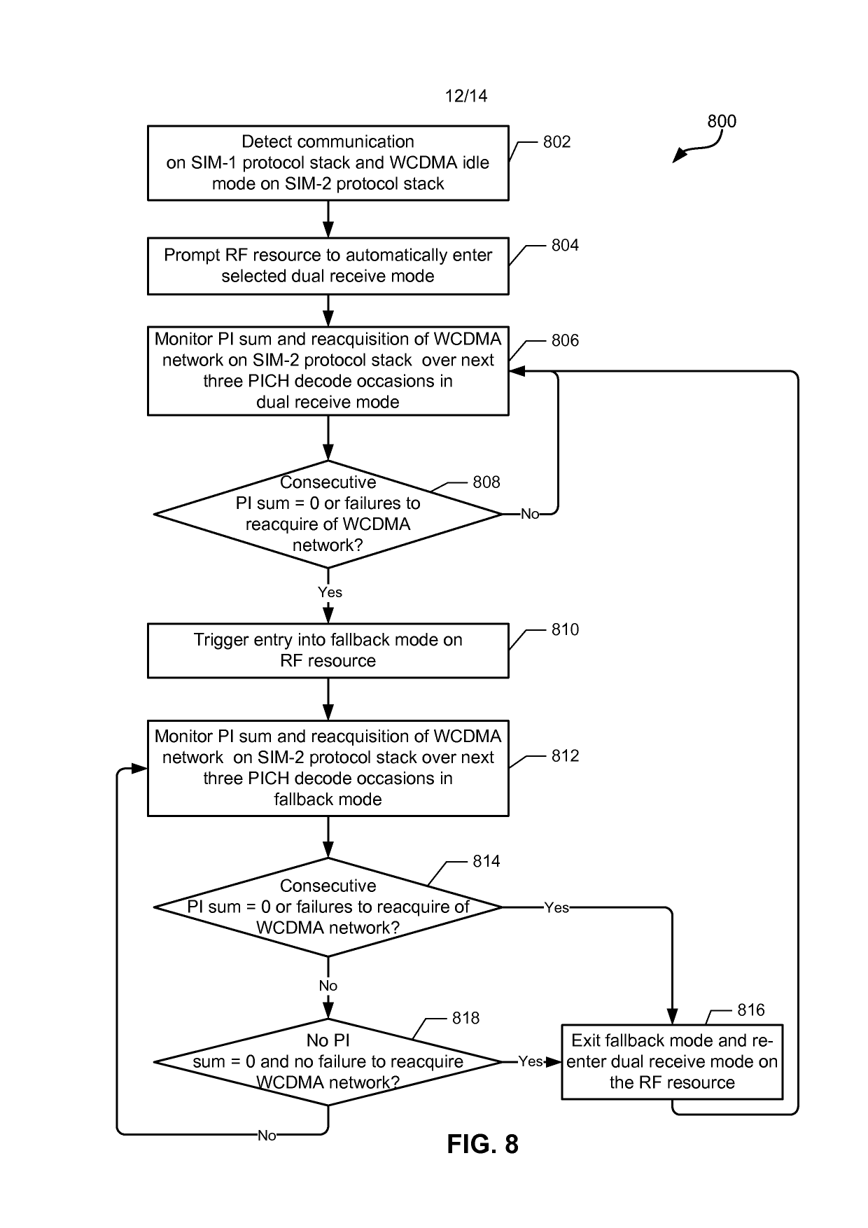

FIG. 8 illustrates a method 800 according to some embodiments that may be implemented in a wireless device (e.g., the wireless device 200 in FIG. 2), such as a MSMS device configured with a first SIM (“SIM-1”) that supports one or more radio access technology, and with a second SIM (“SIM-2”) that supports at least one different radio access technology, such as a WCDMA access standard. While described with reference to a WCDMA network, the embodiment shown in FIG. 8 may be implemented for any of a number of radio access technologies.

With reference to FIGS. 1-8, in block 802 of method 800, the wireless device processor may detect a communication on the protocol stack associated with the first SIM and an idle mode in a WCDMA network on the protocol stack associated with the second SIM.

In block 804, the wireless device processor may prompt the RF resource to enter a selected dual receive mode on the RF resource. As described, the wireless device processor may be configured to employ, by default, dual receive modes over the legacy time-sharing mode in order to obtain the best quality/throughput on each SIM. Further as described, the selected dual receive mode may involve accessing default settings and/or capabilities associated with the baseband-modem processor, RF resource, and/or front end receive components.

In block 806, the wireless device processor may monitor various performance metrics on the protocol stack associated with the second SIM while in the dual receive mode over the next three paging indicator channel (PICH) decode occasions. Such performance metrics may include the decoded paging indicator PI bits as well as any failures to reacquire the WCDMA network for decoding the PICH.

In determination block 808, the wireless device processor may determine whether the sum of the decoded PI bits from the three consecutive PICH decode occasions (PI sum) is zero, and whether there were any failures to reacquire the WCDMA network. In response to determining that the sum of the PI bits is not zero and there were no failures to reacquire the WCDMA network for any of the three PICH decode occasions (i.e., determination block 808=“No”), the wireless device processor may continue to monitor the performance metrics on the protocol stack associated with the second SIM for the next three PICH decode occasions while in the selected dual receive mode in block 806.

In response to determining that the PI sum is equal to zero and/or there was at least one failure to reacquire the WCDMA network for any of the three PICH decode occasions (i.e., determination block 808=“Yes”), the wireless device processor may trigger entry into the fallback mode on the RF resource in block 810. In block 812, the wireless device processor may monitor performance metrics on the protocol stack associated with the second SIM, such as the PI sum and reacquisition of the WCDMA network, for the next three PICH decode occasions while in the fallback mode. In determination block 814, the wireless device processor may determine whether the sum of the decoded PI bits from the three consecutive PICH decode occasions is zero, and whether there were any failures to reacquire the WCDMA network.

In response to determining that the sum of the PI bits is zero and/or there was at least one failure to reacquire the WCDMA network for any of the three PICH decode occasions (i.e., determination block 814=“Yes”), the wireless device processor may prompt the RF resource to exit the fallback mode and re-enter the selected dual receive mode on the second SIM resource in block 816.

In response to determining that the sum of the decoded PI bits from the three PICH decode occasions is not zero and/or there was at least one failure to reacquire the WCDMA network (i.e., determination block 814=“No”), the wireless device processor may determine whether none of the decoded PI bits from the three consecutive PICH decode occasions is zero and no reacquisition failures occurred in determination block 818. In response to determining that one or more PI bit from the three PICH decode occasions is not zero or that there was a reacquisition failure during the three PICH decode occasions (i.e., determination block 818=“No”), the wireless device processor may return to monitoring the performance metrics over the next three PICH decode occasions in fallback mode in block 812. In response to determining that none of the decoded PI bits from the three consecutive PICH decode occasions is zero and no reacquisition failures occurred (i.e., determination block 818=“Yes”), the wireless device processor may prompt the RF resource to exit the fallback mode and re-enter the selected dual receive mode in block 816. The wireless device processor may then return to monitoring the performance metrics over the next three PICH decode occasions in selected dual receive mode in block 806.

Additional RATs for dynamically managing receive modes for an RF resource in a MSMS device may be applied to any of a number of SIMs/protocol stacks. As described, the protocol stacks in various embodiments may support any of a variety of current and/or future protocols for wireless communications. For example, the protocol stacks in various embodiments may support networks using various radio access technologies described in 3GPP standards (e.g., Long Term Evolution (LTE), etc.), 3GPP2 standards (e.g., Evolved Data Optimized (EVDO), Ultra Mobile Broadband (UMB), etc.) and/or IEEE standards Worldwide Interoperability for Microwave Access (WiMAX), Wi-Fi, etc.), and others.

The references to the first SIM (SIM-1) and the second SIM (SIM-2) are arbitrary and used merely for the purposes of describing the embodiments, and the wireless communication device processor may assign any indicator, name, or other designation to differentiate the SIMs and associated protocol stacks. Embodiment methods apply the same regardless of which SIM is participating in a communication and/or which SIM is in idle mode. Further, such designations of SIMs and/or protocol stacks may be switched or reversed between instances of executing the methods herein.

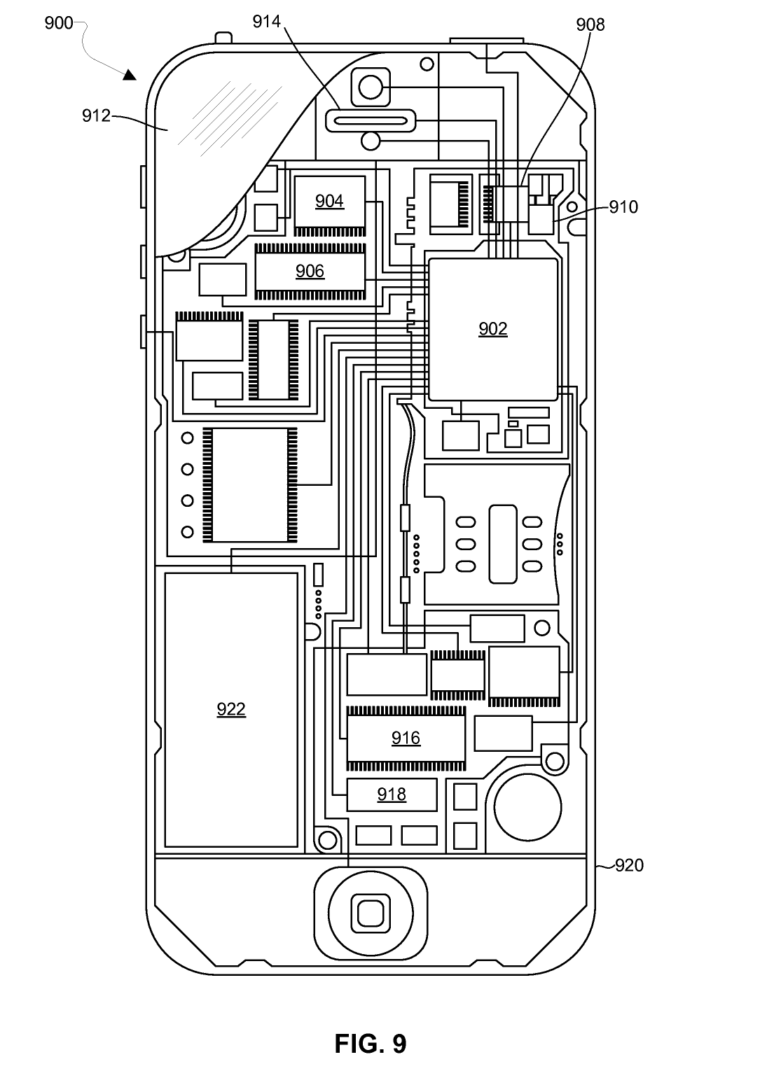

Various embodiments (including, but not limited to, embodiments discussed above with reference to FIGS. 4A-8) may be implemented in any of a variety of wireless devices, an example 900 of which is illustrated in FIG. 9. For example, the wireless device 900 (which may correspond, for example, the wireless devices 102, 200 in FIGS. 1-2) may include a processor 902 coupled to a touchscreen controller 904 and an internal memory 906. The processor 902 may be one or more multicore integrated circuits (ICs) designated for general or specific processing tasks. The internal memory 906 may be volatile or non-volatile memory, and may also be secure and/or encrypted memory, or unsecure and/or unencrypted memory, or any combination thereof.

The touchscreen controller 904 and the processor 902 may also be coupled to a touchscreen panel 912, such as a resistive-sensing touchscreen, capacitive-sensing touchscreen, infrared sensing touchscreen, etc. The wireless device 900 may have one or more radio signal transceivers 908 (e.g., Peanut®, Bluetooth®, ZigBee®, Wi-Fi, RF radio) and antennae 910, for sending and receiving, coupled to each other and/or to the processor 902. The transceivers 908 and antennae 910 may be used with the above-mentioned circuitry to implement the various wireless transmission protocol stacks and interfaces. The wireless device 900 may include a cellular network wireless modem chip 916 that enables communication via a cellular network and is coupled to the processor. The wireless device 900 may include a peripheral device connection interface 918 coupled to the processor 902. The peripheral device connection interface 918 may be singularly configured to accept one type of connection, or multiply configured to accept various types of physical and communication connections, common or proprietary, such as USB, FireWire, Thunderbolt, or PCIe. The peripheral device connection interface 918 may also be coupled to a similarly configured peripheral device connection port (not shown). The wireless device 900 may also include speakers 914 for providing audio outputs. The wireless device 900 may also include a housing 920, constructed of a plastic, metal, or a combination of materials, for containing all or some of the components discussed herein. The wireless device 900 may include a power source 922 coupled to the processor 902, such as a disposable or rechargeable battery. The rechargeable battery may also be coupled to the peripheral device connection port to receive a charging current from a source external to the wireless device 900.

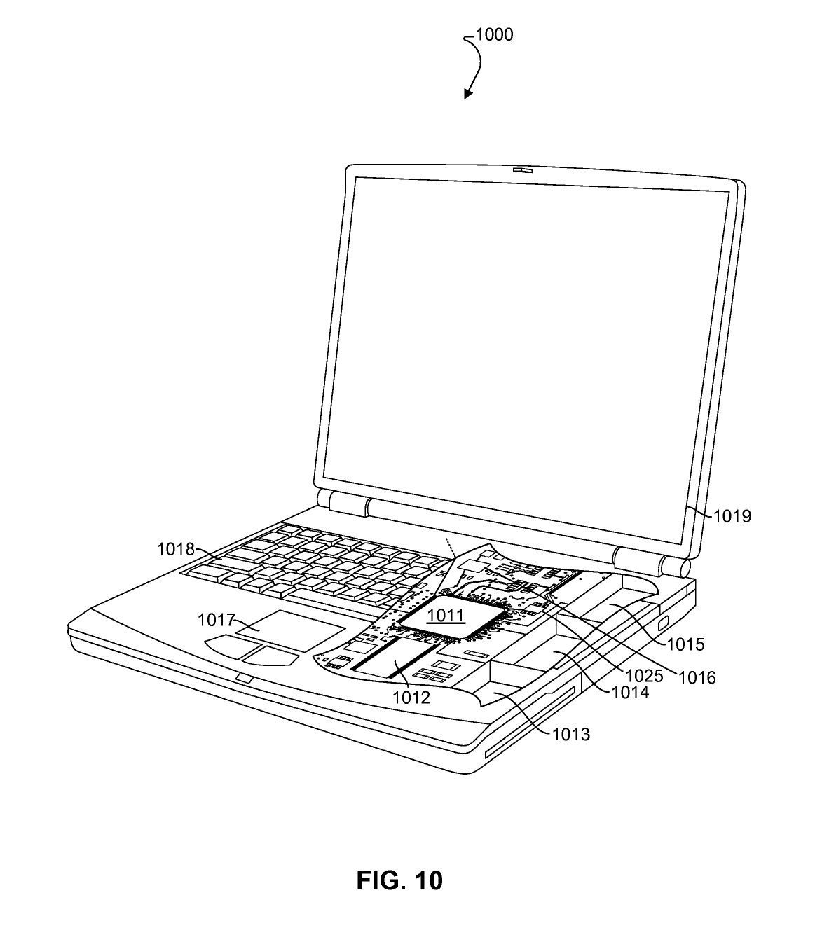

Various embodiments (including, but not limited to, embodiments discussed above with reference to FIGS. 4A-8) described above may also be implemented within a variety of personal computing devices, such as a laptop computer 1000 (which may correspond, for example, the wireless devices 102, 200 in FIGS. 1-2) as illustrated in FIG. 10. Many laptop computers include a touchpad touch surface 1017 that serves as the computer's pointing device, and thus may receive drag, scroll, and flick gestures similar to those implemented on wireless computing devices equipped with a touch screen display and described above. The laptop computer 1000 will typically include a processor 1011 coupled to volatile memory 1012 and a large capacity nonvolatile memory, such as a disk drive 1013 of Flash memory. The laptop computer 1000 may also include a floppy disc drive 1014 and a compact disc (CD) drive 1015 coupled to the processor 1011. The laptop computer 1000 may also include a number of connector ports coupled to the processor 1011 for establishing data connections or receiving external memory devices, such as a USB or FireWire® connector sockets, or other network connection circuits for coupling the processor 1011 to a network. In a notebook configuration, the computer housing includes the touchpad touch surface 1017, the keyboard 1018, and the display 1019 all coupled to the processor 1011. Other configurations of the computing device may include a computer mouse or trackball coupled to the processor (e.g., via a USB input) as are well known, which may also be used in conjunction with various embodiments.

The processors 902 and 1011 may be any programmable microprocessor, microcomputer or multiple processor chip or chips that can be configured by software instructions (applications) to perform a variety of functions, including the functions of various embodiments described above. In some devices, multiple processors may be provided, such as one processor dedicated to wireless communication functions and one processor dedicated to running other applications. Typically, software applications may be stored in the internal memory 906, 1012, and 1013 before they are accessed and loaded into the processors 902 and 1011. The processors 902 and 1011 may include internal memory sufficient to store the application software instructions. In many devices, the internal memory may be a volatile or nonvolatile memory, such as flash memory, or a mixture of both. For the purposes of this description, a general reference to memory refers to memory accessible by the processors 902, 1011, including internal memory or removable memory plugged into the device and memory within the processor 902 and 1011, themselves.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

While the terms “first” and “second” are used herein to describe data transmission associated with a SIM and data receiving associated with a different SIM, such identifiers are merely for convenience and are not meant to limit the various embodiments to a particular order, sequence, type of network or carrier.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary embodiment, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the scope of the claims. Thus, the present invention is not intended to be limited to the embodiments shown herein but is to be accorded the widest scope consistent with the following claims and the principles and novel features disclosed herein.

What is claimed is:

1. A method of implementing dynamic receive mode management on a multi-subscriber identification module (SIM) wireless communication device having at least a first SIM and a second SIM associated with a shared radio frequency (RF) resource, the method comprising:
detecting when a communication of the first SIM in a first network will occur at the same time as an idle mode paging cycle in a second network associated with the second SIM;
prompting entry into a selected dual receive mode on the shared RF resource, wherein the shared RF resource is tuned to the first network, and wherein at least one receive chain associated with the shared RF resource is used for each of receiving signals from the first network and monitoring a paging channel in the second network;
monitoring at least one performance metric for the idle mode paging cycle associated with the second SIM while in the selected dual receive mode;
determining whether paging performance is degraded on a protocol stack associated with the second SIM based on the at least one performance metric monitored while in the selected dual receive mode; and
triggering entry into a fallback mode on the shared RF resource in response to determining that paging performance is degraded on the protocol stack associated with the second SIM,
wherein the shared RF resource tunes away from the first network to the second network during paging periods associated with the second SIM while in the fallback mode.

2. The method of claim 1, further comprising:
monitoring at least one performance metric for the idle mode paging cycle associated with the second SIM while in the fallback mode;
determining whether the paging performance on the protocol stack associated with the second SIM has improved based on the at least one performance metric monitored while in the fallback mode; and
prompting the shared RF resource to exit the fallback mode and re-enter the selected dual receive mode in response to determining that the paging performance on the protocol stack associated with the second SIM has improved.

3. The method of claim 2, further comprising:
prompting the shared RF resource to exit the fallback mode and re-enter the selected dual receive mode following expiration of a preset timer in response to determining that the paging performance on the protocol stack associated with the second SIM has not improved in the fallback mode.

4. The method of claim 2, further comprising:
determining whether the degraded paging performance is likely a result of factors other than the selected dual receive mode in response to determining that the paging performance on the protocol stack associated with the second SIM has not improved in the fallback mode; and
prompting the shared RF resource to exit the fallback mode and re-enter the selected dual receive mode in response to determining that the degraded paging performance is likely a result of factors other than the selected dual receive mode.

5. The method of claim 2, wherein monitoring at least one performance metric for the idle mode paging cycle associated with the second SIM while in the fallback mode comprises monitoring at least one of:
a pilot channel quality measurement;
a paging indicator (PI) bit value;
a demodulation failure rate;
a received signal strength;
an idle mode cyclic redundancy check (CRC) failure rate;
a current downlink signal failure counter (DSC) value;
an average paging channel (PCH) burst signal-to-noise ratio (SNR);
a receive automatic gain control (AGC) value; and
a quick paging channel (QPCH) channel estimate.

6. The method of claim 1, wherein detecting when a communication of the first SIM will occur at the same time as an idle mode paging cycle in a second network associated with the second SIM comprises:
detecting, on a protocol stack associated with the first SIM, an active communication in the first network; and
detecting, on the protocol stack associated with the second SIM, an idle mode paging cycle in the second network.

7. The method of claim 1, wherein determining whether the paging performance is degraded on the protocol stack associated with the second SIM comprises comparing a current value of the at least one performance metric to at least one corresponding entrance threshold.

8. The method of claim 1, wherein determining whether the paging performance on the protocol stack associated with the second SIM has improved comprises comparing a current value of the at least one performance metric to at least one corresponding exit threshold.

9. The method of claim 8, wherein the corresponding exit threshold has a value equal to the corresponding entrance threshold.

10. The method of claim 8, wherein the corresponding exit threshold has a value different from the corresponding entrance threshold.

11. The method of claim 1, wherein monitoring at least one performance metric for the idle mode paging cycle associated with the second SIM while in the selected dual receive mode comprises monitoring at least one of:
a pilot channel quality measurement;
a paging indicator (PI) bit value;
a demodulation failure rate;
a received signal strength;
an idle mode cyclic redundancy check (CRC) failure rate;
a current downlink signal failure counter (DSC) value;
a glitch percentage;
a desense percentage;
a receive automatic gain control (AGC) value; and
a quick paging channel (QPCH) channel estimate.

12. The method of claim 1, wherein the first network is associated with a first radio access technology (RAT), and the second network is associated with a second RAT different from the first RAT.

13. A wireless communication device, comprising:
a shared radio frequency (RF) resource configured to connect to a first subscriber identity module (SIM) and a second SIM; and
a processor coupled to the shared RF resource and configured with processor-executable instructions to:
detect when a communication of the first SIM in a first network will occur at the same time as an idle mode paging cycle in a second network associated with the second SIM;
prompt entry into a selected dual receive mode on the shared RF resource, wherein the shared RF resource is tuned to the first network, and wherein at least one receive chain associated with the shared RF resource is used for each of receiving signals from the first network and monitoring a paging channel in the second network;
monitor at least one performance metric for the idle mode paging cycle associated with the second SIM while in the selected dual receive mode;
determine whether paging performance is degraded on a protocol stack associated with the second SIM based on the at least one performance metric monitored while in the selected dual receive mode; and
trigger entry into a fallback mode on the shared RF resource in response to determining that paging performance is degraded on the protocol stack associated with the second SIM,
wherein the shared RF resource tunes away from the first network and tunes to the second network during paging periods associated with the second SIM while in the fallback mode.

14. The wireless communication device of claim 13, wherein the processor is further configured with processor-executable instructions to:
monitor at least one performance metric for the idle mode paging cycle associated with the second SIM while in the fallback mode;
determine whether the paging performance on the protocol stack associated with the second SIM has improved based on the at least one performance metric monitored while in the fallback mode; and
prompt the shared RF resource to exit the fallback mode and re-enter the selected dual receive mode in response to determining that the paging performance on the protocol stack associated with the second SIM has improved.

15. The wireless communication device of claim 14, wherein the processor is further configured with processor-executable instructions to:
prompt the shared RF resource to exit the fallback mode and re-enter the selected dual receive mode following expiration of a preset timer in response to determining that the paging performance on the protocol stack associated with the second SIM has not improved in the fallback mode.

16. The wireless communication device of claim 14, wherein the processor is further configured with processor-executable instructions to:
determine whether the degraded paging performance is likely a result of factors other than the selected dual receive mode in response to determining that the paging performance on the protocol stack associated with the second SIM has not improved in the fallback mode; and
prompt the shared RF resource to exit the fallback mode and re-enter the selected dual receive mode in response to determining that the degraded paging performance is likely a result of factors other than the selected dual receive mode.

17. The wireless communication device of claim 14, wherein the processor is further configured with processor-executable instructions to monitor at least one performance metric for the idle mode paging cycle associated with the second SIM while in the fallback mode by monitoring at least one of:
a pilot channel quality measurement;
a paging indicator (PI) bit value;
a demodulation failure rate;
a received signal strength;
an idle mode cyclic redundancy check (CRC) failure rate;
a current downlink signal failure counter (DSC) value;
an average paging channel (PCH) burst signal-to-noise ratio (SNR);
a receive automatic gain control (AGC) value; and
a quick paging channel (QPCH) channel estimate.

18. The wireless communication device of claim 13, wherein the processor is further configured with processor-executable instructions to detect when a communication of the first SIM will occur at the same time as an idle mode paging cycle in a second network associated with the second SIM by:
detecting, on a protocol stack associated with the first SIM, an active communication in the first network; and
detecting, on the protocol stack associated with the second SIM, an idle mode paging cycle in the second network.

19. The wireless communication device of claim 13, wherein the processor is further configured with processor-executable instructions to determine whether the paging performance is degraded on the protocol stack associated with the second SIM by comparing a current value of the at least one performance metric to at least one corresponding entrance threshold.

20. The wireless communication device of claim 13, wherein the processor is further configured with processor-executable instructions to determine whether the paging performance on the protocol stack associated with the second SIM has improved by comparing a current value of the at least one performance metric to at least one corresponding exit threshold.

21. The wireless communication device of claim 20, wherein the corresponding exit threshold has a value equal to the corresponding entrance threshold.

22. The wireless communication device of claim 20, wherein the corresponding exit threshold has a value different from the corresponding entrance threshold.

23. The wireless communication device of claim 13, wherein the processor is further configured with processor-executable instructions to monitor at least one performance metric for the idle mode paging cycle associated with the second SIM while in the selected dual receive mode by monitoring at least one of:
a pilot channel quality measurement;
a paging indicator (PI) bit value;
a demodulation failure rate;
a received signal strength;
an idle mode cyclic redundancy check (CRC) failure rate;
a current downlink signal failure counter (DSC) value;
a glitch percentage;
a desense percentage;
a receive automatic gain control (AGC) value; and
a quick paging channel (QPCH) channel estimate.

24. The wireless communication device of claim 13, wherein the first network is associated with a first radio access technology (RAT), and the second network is associated with a second RAT different from the first RAT.

25. A wireless communication device, comprising:
a radio frequency (RF) resource configured to be coupled to a first subscriber identity module (SIM) and a second SIM; and
means for detecting when a communication of the first SIM will occur at the same time as an idle mode paging cycle in a second network associated with the second SIM;
means for prompting entry into a selected dual receive mode on the shared RF resource, wherein the shared RF resource is tuned to a first network, and wherein at least one receive chain associated with the shared RF resource is used for each of receiving signals from the first network and monitoring a paging channel in the second network;
means for monitoring at least one performance metric for the idle mode paging cycle associated with the second SIM while in the selected dual receive mode;
means for determining whether paging performance is degraded on a protocol stack associated with the second SIM based on the at least one performance metric monitored while in the selected dual receive mode; and
means for triggering entry into a fallback mode on the shared RF resource in response to determining that paging performance is degraded on the protocol stack associated with the second SIM,
wherein the shared RF resource tunes away from the first network and to the second network during paging periods associated with the second SIM while in the fallback mode.

26. A non-transitory processor-readable storage medium having stored thereon processor-executable instructions configured to cause a processor of a wireless communication device having a radio frequency (RF) resource configured to connect to a first subscriber identity module (SIM) and a second SIM to perform operations comprising:
detecting when a communication of the first SIM will occur at the same time as an idle mode paging cycle in a second network associated with the second SIM;
prompting entry into a selected dual receive mode on the shared RF resource, wherein the shared RF resource is tuned to a first network, wherein at least one receive chain associated with the shared RF resource is used for each of receiving signals from the first network and monitoring a paging channel in the second network;
monitoring at least one performance metric for the idle mode paging cycle associated with the second SIM while in the selected dual receive mode;
determining whether paging performance is degraded on the protocol stack associated with the second SIM based on the at least one performance metric monitored while in the selected dual receive mode; and
triggering entry into a fallback mode on the shared RF resource in response to determining that paging performance is degraded on the protocol stack associated with the second SIM,
wherein the shared RF resource tunes away from the first network and to the second network during paging periods associated with the second SIM while in the fallback mode.
